(19) United States
(12) Patent Application Publication
(10) Pub. No.: US 2023/0322228 A1
(43) Pub. Date: Oct. 12, 2023

(54) VEHICLE CONTROL APPARATUS

(71) Applicant: Mitsubishi Electric Corporation, Tokyo (JP)

(72) Inventors: Kenta TOMINAGA, Tokyo (JP); Takayuki TANAKA, Tokyo (JP); Hiroaki KITANO, Tokyo (JP); Shogo OKAMOTO, Tokyo (JP)

(73) Assignee: Mitsubishi Electric Corporation, Tokyo (JP)

(21) Appl. No.: 18/158,817

(22) Filed: Jan. 24, 2023

(30) Foreign Application Priority Data
Apr. 8, 2022 (JP) 2022-064242

(51) Int. Cl. B60W 30/18; B60W 40/10; G08G 1/16

(52) U.S. Cl. CPC B60W 30/18163; B60W 2554/00; G08G 1/167; B60W 40/10

(57) ABSTRACT

There is provided a vehicle control apparatus that can correctly determine that lane changing is possible in a situation that by accelerating or decelerating, an ego vehicle can perform the lane changing without interfering with an obstacle, and that raises the comfortability for the drier. In the vehicle control apparatus, a target trajectory for performing lane changing under restriction of not entering an entry prohibition region is calculated; a determination section determines whether or not lane changing is possible, based on at least information on a position of the ego vehicle in the target trajectory; in the case where it is determined that lane changing is possible, the ego vehicle is made to change a lane, by use of the target trajectory.

### INCORPORATION BY REFERENCE

The disclosure of Japanese Patent Application No. 2022-64242 filed on Apr. 8, 2022 including its specification, claims and drawings, is incorporated herein by reference in its entirety.

### BACKGROUND

The present disclosure relates to a vehicle control apparatus.

Various kinds of technologies for controlling travel of a vehicle have been proposed. As one of them, there has been developed an apparatus that controls lane changing in which a vehicle moves from the present lane to an adjacent lane. For example, a vehicle control apparatus according to JP 6569186 B determines that lane changing is possible, when the prediction lane of an ego vehicle and the prediction lane of another vehicle do not interfere with each other, and then performs the lane changing.

### SUMMARY

In the vehicle control apparatus according to JP 6569186 B, because trajectory generation and interference determination are performed separately, it is determined that interference occurs even when a vehicle can perform lane changing without interfering with an obstacle by accelerating or decelerating; thus, the vehicle misses the opportunity for lane changing and hence the comfortability is deteriorated.

Thus, the objective of the present disclosure is to provide a vehicle control apparatus that can correctly determine that lane changing is possible in such a situation that an ego vehicle can change lanes without interfering with an obstacle by accelerating or decelerating its speed.

A vehicle control apparatus according to the present disclosure includes an entry-prohibition-region setting section that sets an entry prohibition region of an ego vehicle, based on movement prediction for an obstacle, a target-trajectory generation section that calculates a target trajectory for the ego vehicle to change a lane to a target lane in the prediction-period future under restriction of not entering the entry prohibition region, a determination section that determines whether or not the ego vehicle can change a lane, based on the target trajectory, and a vehicle control section that makes the ego vehicle change a lane by use of the target trajectory, when the determination section determines that the ego vehicle can change the lane; the target trajectory includes information related to at least a position of the ego vehicle; the determination section determines whether or not lane changing is possible, based on at least information on a position of the ego vehicle in the target trajectory.

Because in the vehicle control apparatus according to the present disclosure, the trajectory is generated while considering an entry prohibition region, it is made possible that in a situation that when the ego vehicle accelerates or decelerates, lane changing can be performed, it is correctly determined that the lane changing is possible; thus, the comfortability for the driver is raised.

### BRIEF DESCRIPTION OF THE DRAWINGS

FIG. 1 is a block diagram representing an example of a vehicle control apparatus according to Embodiment 1;

FIG. 2 is a diagram representing an example of an ego vehicle according to Embodiment 1;

FIG. 3 is a chart representing an example of a coordinate system according to Embodiment 1;

FIG. 4 is a chart representing an example of a route coordinate system according to Embodiment 1;

FIG. 5 is a flowchart representing an example of an automatic-driving procedure for the ego vehicle according to Embodiment 1;

FIG. 6 is a flowchart representing an example of a target-trajectory generation procedure according to Embodiment 1;

FIG. 7 is a flowchart representing an example of a determination procedure according to Embodiment 1;

FIG. 8 is a schematic chart representing an example of a determination based on an attainment degree of a target lane-changing trajectory according to Embodiment 1;

FIG. 9 is a schematic chart representing another example of the determination based on the attainment degree of the target lane-changing trajectory according to Embodiment 1;

FIG. 10 is a set of schematic charts representing another example of the determination based on the attainment degree of the target lane-changing trajectory according to Embodiment 1;

FIG. 11 is a set of schematic charts representing an example of the validity of the determination based on the attainment degree of the target lane-changing trajectory according to Embodiment 1;

FIG. 12 is a set of schematic charts representing another example of the determination based on the attainment degree of the target lane-changing trajectory according to Embodiment 1;

FIG. 13 is a set of schematic charts representing another example of the validity of the determination based on the attainment degree of the target lane-changing trajectory according to Embodiment 1;

FIG. 14 is a set of schematic charts representing an example of a determination based on the number of steering changes for the target lane-changing trajectory according to Embodiment 1;

FIG. 15 is a set of schematic charts representing an example of the validity of the determination based on the number of steering changes for the target lane-changing trajectory according to Embodiment 1;

FIG. 16 is a set of schematic charts representing another example of the determination based on the number of steering changes for the target lane-changing trajectory according to Embodiment 1;

FIG. 17 is a set of schematic charts representing another example of the validity of the determination based on the number of steering changes for the target lane-changing trajectory according to Embodiment 1;

FIG. 18 is a flowchart representing an example of a determination procedure according to Embodiment 4;

FIG. 19 is a block diagram representing an example of a vehicle control apparatus according to Embodiment 5;

FIG. 20 is a chart representing an example of the reliability of motion prediction according to Embodiment 6;

FIG. 21 is a chart representing another example of the reliability of the movement prediction according to Embodiment 6;

FIG. 22 is a flowchart representing an example of a determination procedure according to Embodiment 7; and

FIG. 23 is a schematic hardware configuration diagram of each of a vehicle control unit and the vehicle control apparatus according to Embodiment 1.

### DETAILED DESCRIPTION OF THE EMBODIMENTS

### Embodiment 1

### <Block Diagram>

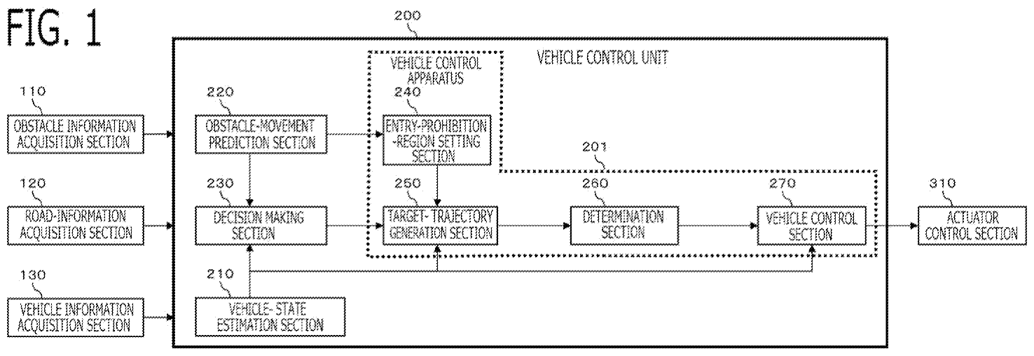

FIG. 1 is a block diagram representing an example of a vehicle control apparatus 201 according to Embodiment 1 of the present disclosure. The vehicle control apparatus 201 according to Embodiment 1 is included in a vehicle control unit 200 of a vehicle. In the following explanation, the vehicle provided with the vehicle control apparatus 201 may be referred to also as an “ego vehicle”.

The vehicle control apparatus 201 in FIG. 1 includes an entry-prohibition-region setting section 240, a target-trajectory generation section 250, a determination section 260, and a vehicle control section 270. The vehicle control unit 200 controls a vehicle and is mounted, for example, in an Advanced Driver-Assistance System electronic control unit (ADAS-ECU).

Based on obstacle-movement prediction information, which is prediction information that is outputted by an obstacle-movement prediction section 220 and includes the position of an obstacle, the entry-prohibition-region setting section 240 sets an entry prohibition region around the predicted obstacle.

The target-trajectory generation section 250 generates a target trajectory on which the ego vehicle should travel, based on road information, which is information that is outputted by a road-information acquisition section 120 and includes the respective boundary portions of a road on which the ego vehicle travels and a road adjacent to the particular road, decision-making information, which is information that is outputted by a decision making section 230 and includes a target action to be taken by the ego vehicle and a target lane on which the ego vehicle should travel, and the entry prohibition region outputted by the entry-prohibition-region setting section 240.

When the target action outputted from the decision making section 230 changes to lane changing, the determination section 260 determines the feasibility of lane changing, based on the target trajectory outputted from the target-trajectory generation section 250.

The vehicle control section 270 calculates a target value for performing steering control and vehicle-speed control so that the ego vehicle follows a target trajectory. As a result, in the case where the determination section 260 determines that lane changing is possible, the ego vehicle can change lanes. In addition, the target value signifies a target steering angle, a target acceleration, or the like.

The vehicle control unit 200 is connected with an obstacle information acquisition section 110, the road-information acquisition section 120, and a vehicle information acquisition section 130, as external input apparatuses.

The obstacle information acquisition section 110 is an acquisition section that acquires obstacle information, which is information including the position of an obstacle; for example, it may be a LiDAR (Light Detection and Ranging) apparatus, a radar, a sonar, an inter-vehicle communication apparatus, a road-vehicle communication apparatus, or the like.

The road-information acquisition section 120 is an acquisition section that acquires road information, which is information including the boundary portion of a road on which the ego vehicle travels; for example, it may be a combination of a LiDAR apparatus and a map data processing apparatus or a combination of the global navigation satellite system (GNSS) and a map data processing apparatus. The boundary portion may be, for example, a lane line, a curb stone, a side groove, or a guard rail.

The vehicle information acquisition section 130 is an acquisition section that acquires vehicle information on the ego vehicle. The vehicle information acquisition section 130 may be, for example, a steering angle sensor, a steering torque sensor, a yaw-rate sensor, a speed sensor, or an acceleration sensor. The vehicle information signifies a present vehicle-state of the ego vehicle and is acquired, for example, by use of at least one of these sensors

The vehicle control unit 200 has a vehicle-state estimation section 210, the obstacle-movement prediction section 220, and the decision making section 230, as the internal constituent elements, that are connected with the vehicle control apparatus 201.

Based on the vehicle information, the vehicle-state estimation section 210 estimates the present vehicle-state of the ego vehicle, which is not acquired by the vehicle information acquisition section 130. In addition, the vehicle-state estimation section 210 may estimate part of the vehicle information acquired by the vehicle information acquisition section 130.

The obstacle-movement prediction section 220 performs movement prediction for an obstacle, based on the obstacle information, which is information outputted from the obstacle information acquisition section 110 and includes the position of the obstacle and the road information, which is information outputted from the road-information acquisition section 120 and includes the respective boundary portions of a road on which the ego vehicle travels and a road adjacent to the particular road.

The decision making section 230 determines a target action to be taken by the ego vehicle and a target lane on which the ego vehicle should travel, based on the obstacle information, the road information, and the vehicle information. The target action is, for example, lane keeping or lane changing. The target lane is, for example, an ego lane, a left lane, and a right lane.

The vehicle control unit 200 is connected with an actuator control section 310, as an external output apparatus. The actuator control section 310 is a control section that controls an actuator, based on a target value from the vehicle control apparatus 201, and may be, for example, an EPS-ECU (Electric Power Steering-Electric Control Unit), a power train ECU, a brake ECU, or an electric automobile ECU. In the present embodiment, it is assumed that the vehicle control unit 200 performs steering control and vehicle-speed control and that the actuator control section 310 includes an EPS-ECU, a power train ECU, and a brake ECU; however, the present invention is not limited thereto.

### <System Configuration Diagram>

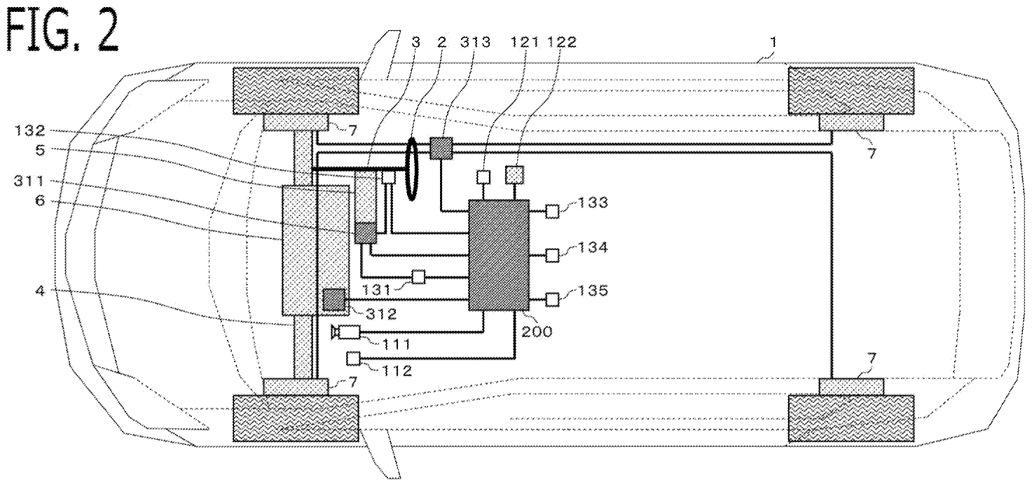

FIG. 2 is a system configuration diagram representing the schematic configuration of the vehicle control apparatus according to Embodiment 1. An ego vehicle 1 includes a steering wheel 2, a steering shaft 3, a steering unit 4, an EPS motor 5, a power train unit 6, a brake unit 7, a front camera 111, a radar sensor 112, a GNSS 121, a navigation apparatus 122, a steering angle sensor 131, a steering torque sensor 132, a yaw-rate sensor 133, a speed sensor 134, an acceleration sensor 135, the vehicle control unit 200, an EPS controller 311, a power train controller 312, and a brake controller 313. In addition, the group of the EPS controller 311, the power train controller 312, and the brake controller 313 corresponds to the foregoing actuator control section 310.

The steering wheel 2 provided for a driver to operate the ego vehicle 1 is coupled with the steering shaft 3. The steering unit 4 is joined to the steering shaft 3. The steering unit 4 pivotably supports the front tires, as the steering tires, and is steerably supported by the vehicle frame. Accordingly, torque produced through the driver's operation of the steering wheel 2 rotates the steering shaft 3, so that the steering unit 4 turns steering of the front tires to the left or right direction. As a result, the driver can operate a transversal traveling amount of the vehicle at a time when the vehicle travels forward or backward. In addition, the steering shaft 3 can also be rotated by the EPS motor 5; when a current flowing in the EPS motor 5 is controlled by the EPS controller 311, the front tires can freely be turned independently from the driver's operation of the steering wheel 2.

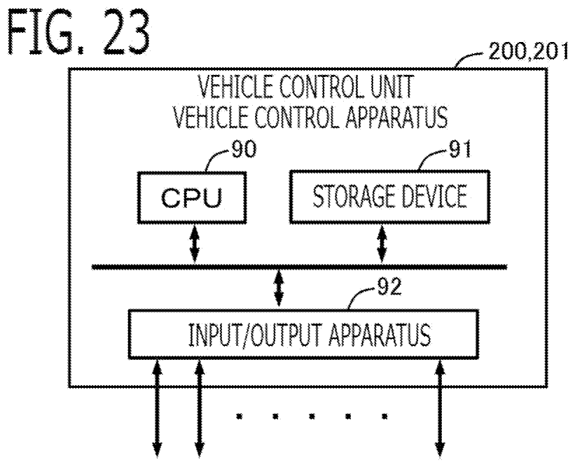

For example, as represented in FIG. 23, the vehicle control unit 200 is provided with a computing processing unit 90 such as a CPU (Central Processing Unit), a storage apparatus 91, an input/output apparatus 92 for inputting external signals to the computing processing unit 90 or outputting signals from the computing processing unit 90 to the outside, and the like.

It may be allowed that as the computing processing unit 90, an ASIC (Application Specific Integrated Circuit), an IC (Integrated Circuit), a DSP (Digital Signal Processor), an FPGA (Field Programmable Gate Array), a GPU (Graphics Processing Unit), an AI (Artificial Intelligence) chip, any one of various kinds of logic circuits, any one of various kinds of signal processing circuits, or the like is provided. In addition, it may be allowed that as the computing processing unit 90, two or more computing processing units of the same type or different types are provided and respective processing items are implemented in a sharing manner. As the storage apparatus 91, there is utilized any one of various kinds of storage apparatuses such as a RAM (Random Access Memory), a ROM (Read Only Memory), a flash memory, an EEPROM (Electrically Erasable Programmable Read Only Memory), a hard disk, and a DVD.

The input/output apparatus 92 is provided with a communication apparatus, an A/D converter, an input/output port, a driving circuit, and the like. The input/output apparatus 92 is connected with the front camera 111, the radar sensor 112, the GNSS 121, the navigation apparatus 122, the steering angle sensor 131 for detecting a steering angle, the steering torque sensor 132 for detecting steering toque, the yaw-rate sensor 133 for detecting a yaw rate, the speed sensor 134 for detecting the speed of the ego vehicle, the acceleration sensor 135 for detecting the acceleration of the ego vehicle, the EPS controller 311, the power train controller 312, and the brake controller 313.

The vehicle control unit 200 processes information pieces inputted from the sensors connected therewith, in accordance with a program stored in the ROM, transmits a target steering angle to the EPS controller 311, and transmits a target acceleration to the power train controller 312 and the brake controller 313.

The front camera 111 is provided at a position where a lane line in front of the vehicle can be detected, as an image, and detects the front environments of the ego vehicle, such as lane information and the position of an obstacle. In addition, in the present embodiment, only a camera that detects the front environments has been cited as an example; however, it may be allowed that a camera that detects the rear and side environments is provided.

The radar sensor 112 irradiates a radar beam and detects the reflected wave thereof so as to outputs the relative distance and the relative speed between the ego vehicle 1 and an obstacle. As the radar sensor, an apparatus based on a well-known method such as a millimeter wave radar, a LiDAR apparatus, a laser range finder, or an ultrasound radar can be utilized.

The GNSS sensor 121 receives electric waves from positioning satellites through an antenna and performs positioning calculation so as to output the absolute position and the absolute azimuth of the ego vehicle.

The navigation apparatus 122 has a function of calculating an optimal traveling route for a destination set by a driver and stores road information pieces on traveling routes. The road information is map node data for expressing road-line shapes; each map node data integrally includes the absolute position (latitude, longitude, altitude), the lane width, the cant angle, the inclination-angle information, and the like at each of nodes.

The EPS controller 311 controls the EPS motor 5, based on the target steering angle transmitted from the vehicle control unit 200.

The power train controller 312 controls the power train unit 6 so as to realize the target acceleration transmitted from the vehicle control unit 200. In addition, in the present embodiment, a vehicle whose driving force source is only an engine has been cited as an example; however, it may be allowed that the present invention is applied to a vehicle whose driving force source is only an electric motor, a vehicle whose driving force sources are both an engine and an electric motor, or the like.

The brake controller 313 controls the brake unit 7 so as to realize the target acceleration transmitted from the vehicle control unit 200.

### <Coordinate System>

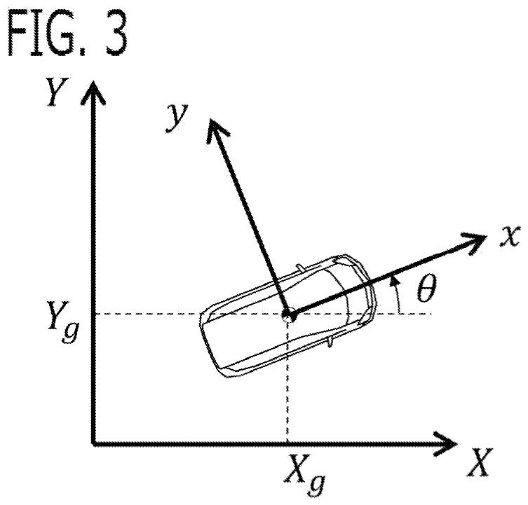

FIG. 3 is a chart symbolically representing a coordinate system to be utilized in Embodiment 1. The (X,Y) in FIG. 3 represents an inertial coordinate system; (Xg, Yg) and θ denote the gravity center position and the vehicle body yaw angle, respectively, of the ego vehicle in the inertial coordinate system. The (x, y) is an ego-vehicle coordinate system in which the origin is the gravity center of the ego vehicle and in which the x axis is the front direction of the ego vehicle and the y axis is the left direction thereof.

In addition, in the present embodiment, the gravity center position (Xg, Yg) and the vehicle body yaw angle θ of the vehicle are initialized every execution period. That is to say, the inertial coordinate system and the ego-vehicle coordinate system are made to coincide with each other every execution period.

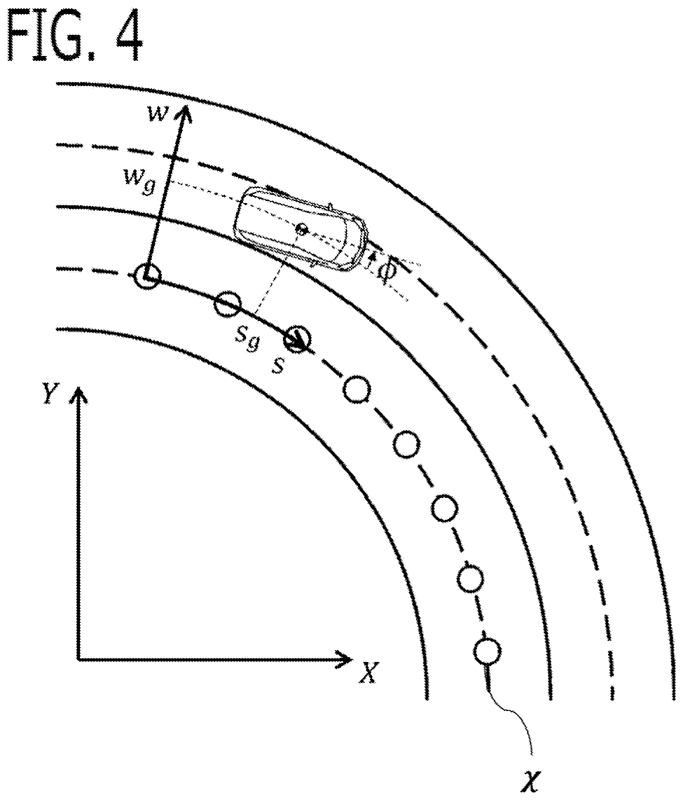

Moreover, in the present embodiment, in an trajectory χ, there is utilized a route coordinate system that is expressed by the tangential direction s and the normal direction w of the trajectory χ. FIG. 4 is a chart symbolically representing a route coordinate system to be utilized in Embodiment 1. The row of points indicates the trajectory χ; in this case, the trajectory x is the lane center. In this regard, however, the route is not limited to the lane center, as long as it is a row of points. The (s, w) in FIG. 4 is a route coordinate system; (sg, wg) and φ are the gravity center position and the vehicle body yaw angle, respectively, in the route coordinate system.

### <Setting of Optimization Problem>

In the present embodiment, the target-trajectory generation section predicts a vehicle-state x every prediction interval Ts from the present time point 0 to a prediction-period Th future, by use of a vehicle model f mathematically expressing motion of the vehicle, and solves, under restriction g, an optimization problem for obtaining series data of a control input u that minimizes an evaluation function J representing desired operation of the ego vehicle. Then, based on the optimized control input u obtained from the optimization problem and the vehicle model f, the target-trajectory generation section predicts, every prediction interval Ts, the series data of the optimized vehicle-state x from the present time point 0 to the prediction-period Th future. After that, based on the series data of the optimized control input u and the series data of the vehicle-state x, the target-trajectory generation section generates an trajectory which is series data including the position of the ego vehicle. In addition, in the following explanation, the time from the present time point to Th may be abbreviated as a horizon.

### <Formulation of Optimization Problem>

As described above, in the present embodiment, an optimization problem with restriction is solved every constant period. The optimization problem is formulated as follows.

$${min}_{u} J s . t . \dot{x} = f ( x , u ) \qquad ( 101 )$$

$${x}_{0} = x ( 0 ) g ( x , u ) \leq 0 \qquad ( 102 )$$

In this situation, J is an evaluation function; x is a vehicle-state; u is a control input; f is a vector-valued function related to a dynamic vehicle model; x0 is an initial value, i.e., the present vehicle-state. “g” is a vector-valued function related to restriction and is for setting the respective upper/under limit values of the vehicle-state x and the control input u in an optimization problem with restriction; the optimization is performed under the condition that the restriction g (x,u)≤0. In addition, in the present embodiment, the foregoing optimization problem is dealt with as a minimization problem; however, the optimization problem can be dealt with as a maximization problem by inverting the signs of the evaluation function.

In the present embodiment, as the evaluation function J, the following equation is utilized.

$$J = {( {h}_{N} ( x ( N ) ) - r ( N ) )}^{T} {W}_{N} ( {h}_{N} ( x ( N ) ) - r ( N ) ) + {\sum }_{k = 0}^{N - 1} {( h ( x ( k ) , u ( k ) ) - r ( k ) )}^{T} W ( h ( x ( k ) , u ( k ) ) - r ( k ) ) \qquad ( 103 )$$

In this situation, x(k) is the vehicle-state at a prediction point k (k=0, . . . , N); u(k) is the control input at a prediction point k (k=0, . . . , N). “h” is a vector-valued function related to evaluation items; hN is a vector-valued function related to the evaluation items at the terminal end (prediction point N); r(k) is the reference value at the prediction point k (k=0, . . . , N). Each of W and WN is a weighting matrix, i.e., a diagonal matrix whose diagonal components have weights for the respective evaluation items; each of W and WN can appropriately be changed as parameters.

### <Vehicle Model>

In the present embodiment, the vehicle-state x and the control input u to be utilized in a control amount calculation section are set as follows.

x=[X_{g},Y_{g},θ,β,γ,V,aₓ,aₓₜ,δ,δₜ]^{T} (104)

u=[jₓₜ,ωₜ]^{T} (105)

In the above equations, β is a sideslip angle; γ is a yaw rate; ax is longitudinal acceleration; δ is a steering angle; axt is target longitudinal acceleration; δt is target steering angle. jxt is target longitudinal jerk, and ωt is target steering angular speed. In addition, as long as a variable related to a position is included in the vehicle-state x and a variable related to steering and a velocity is included in any of the vehicle-state x and the control input u, each of the vehicle-state x and the control input u can arbitrarily be set. Moreover, the positional variable is not limited to being defined by an orthogonal coordinate system; it may be defined by a route coordinate system. In addition, in the case where the vehicle control apparatus performs only steering control and as long as a variable related to a position is included in the vehicle-state x and a variable related to steering is included in any of the vehicle-state x and the control input u, each of the vehicle-state x and the control input u can arbitrarily be set.

As the vehicle model f, a two-wheel model given below is utilized.

$$\dot{x} = f ( x ) = [ \begin{matrix}V cos ( θ + β ) \\ V sin ( θ + β ) \\ γ \\ - γ + \frac{2}{MV} ( {F}_{f} + {F}_{r} ) \\ \frac{2}{I} ( {l}_{f} {F}_{f} - {l}_{r} {F}_{r} ) \\ {a}_{x} \\ \frac{{a}_{xt} - {a}_{x}}{{T}_{{a}_{x}}} \\ {j}_{xt} \\ \frac{{δ}_{o} - δ}{{T}_{δ}} \\ {ω}_{t}\end{matrix} ] \qquad ( 106 )$$

In the above equation, M is vehicle mass, and I is the yaw inertia moment of a vehicle. Lf is the distance from the wheel axle of the front wheels to the vehicle gravity center, and lr is the distance from the wheel axle of the rear wheels to the vehicle gravity center. Tax is a time constant at a time when the trackability of the longitudinal acceleration to the target value is expressed by a first-order-lag system; Tδ is a time constant at a time when the trackability of the steering angle to the target value is expressed by a first-order-lag system. Yf is cornering force of the front wheel and is expressed by the equation (107), by use of front-wheel cornering stiffness Cf; Yr is cornering force of the rear wheel and is expressed by the equation (108), by use of rear-wheel cornering stiffness Cr.

$${Y}_{f} = - {C}_{f} ( β + \frac{{l}_{f}}{V} γ - δ ) \qquad ( 107 )$$

$${Y}_{r} = - {C}_{r} ( β - \frac{{l}_{r}}{V} γ ) \qquad ( 108 )$$

In addition, as the vehicle model f, a vehicle model other than the two-wheel model may be utilized.

### <Procedure in Vehicle Control Apparatus>

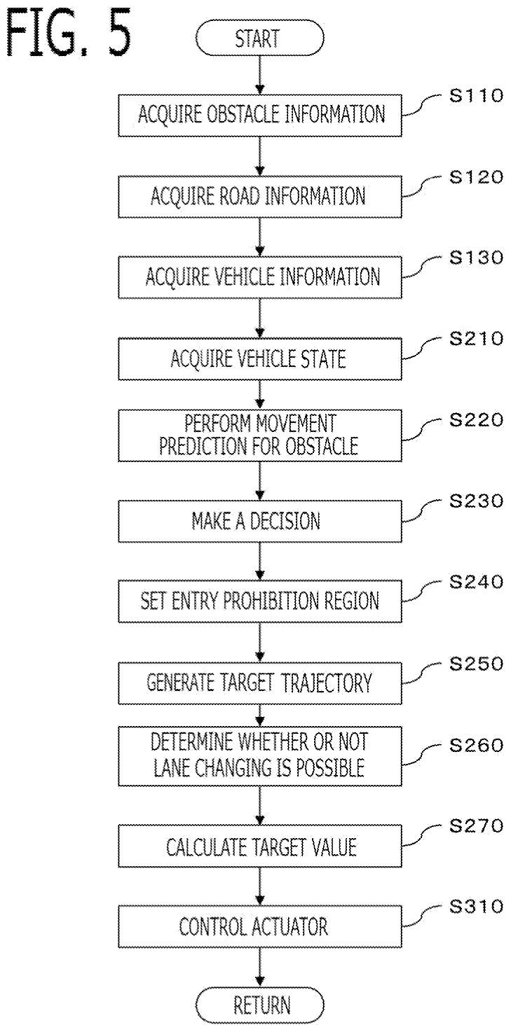

FIG. 5 is a flowchart representing an example of an automatic-driving procedure for the ego vehicle according to Embodiment 1.

In S110 in FIG. 5, the obstacle information acquisition section 110 acquires obstacle information. The obstacle information includes the position of an obstacle; in the present embodiment, it is assumed that in the case where the obstacle exists at the front left of the ego vehicle, the respective ego-vehicle-coordinate-system positions of the front right end PFR, the rear right end PRR, and the rear left end PRL of the obstacle are acquired and that in the case where the obstacle exists at the front right of the ego vehicle, the respective ego-vehicle-coordinate-system positions of the front left end PFL, the rear left end PRL, and the rear right end PRR of the obstacle are acquired. Moreover, based on those positional information pieces, the obstacle information acquisition section 110 estimates the position of the front left end PFL or the front right end PFR, the position (Xo,Yo) of the center PC, the vehicle body yaw angle θo, the speed Vo, the length lo, and the width wo.

Next, in S120 in FIG. 5, the road-information acquisition section 120 acquires road information. The road information includes the respective boundary portions of a road on which the ego vehicle travels and a road adjacent to the particular road (hereinafter, described as an ego lane, a left lane, and a right lane); in the present embodiment, it is assumed that there are acquired coefficients at a time when the respective left and right lane lines of the ego lane, the left lane, and the right lane are expressed by polynomials. That is to say, as far as the lane line at the left of the ego lane (it is also the right lane line of the left lane) is concerned, the values cel0 through cel3 are acquired.

Y=cₑₗ₃X³+cₑₗ₂X²+cₑₗ₁X+cₑₗ₀ (109)

As far as the lane line at the right of the ego lane (it is also the left lane line of the right lane) is concerned, the values cer0 through cer3 are acquired.

Y=cₑᵣ₃X³+cₑᵣ₂X²+cₑᵣ₁X+cₑᵣ₀ (202)

As far as the left lane line of the left lane is concerned, the values cll0 through cll3 in the following equation are acquired.

Y=cₗₗ₃X³+cₗₗ₂X²+cₗₗ₁X+cₗₗ₀ (203)

As far as the right lane line of the right lane is concerned, the values crr0 through crr3 in the following equation are acquired.

Y=cᵣᵣ₃X³+cᵣᵣ₂X²+cᵣᵣ₁X+cᵣᵣ₀ (204)

In this situation, the ego lane center, the left-lane center, and the right-lane center are expressed by the equations (205), (206), and (207), respectively.

Y=lₑ(X)=c_{ec3}X³+c_{ec2}X²+c_{ec1}X+c_{ec0} (205)

Y=lₗ(X)=c_{lc3}(X)³+c_{lc2}X²+c_{lc1}X++c_{lc0} (206)

Y=lr(X)=c_{rc3}X³+c_{rc2}X²+c_{rc1}X+c_{rc0} (207)

The respective coefficients are expressed by the equations (208), (209), and (210).

$${c}_{e c i} = \frac{( {c}_{eli} + {c}_{eri} )}{2} ( i = 0 , … , 3 ) \qquad ( 208 )$$

$${c}_{l c i} = \frac{( {c}_{eli} + {c}_{lli} )}{2} ( i = 0 , … , 3 ) \qquad ( 209 )$$

$${c}_{rci} = \frac{( {c}_{eri} + {c}_{rri} )}{2} ( i = 0 , … , 3 ) \qquad ( 210 )$$

In addition, the information on the lane line is not limited to being expressed by a polynomial but may be expressed by an arbitrary function.

In S130 in FIG. 5, the vehicle information acquisition section 130 acquires vehicle information. The vehicle information includes the steering angle, the yaw rate, the speed, the acceleration, and the like of the ego vehicle; in the present Embodiment, it is assumed that the steering angle δ, the yaw rate γ, the speed V, and the longitudinal acceleration ax are acquired.

Next, in S210 in FIG. 5, the vehicle-state estimation section 210 estimates the vehicle-state x. In the estimation of the vehicle-state, publicly known technologies such as a low-pass filter, an observer, a Kalman filter, and a particle filter are utilized.

Next, in S220 in FIG. 5, the obstacle-movement prediction section 220 performs movement prediction for the obstacle. In the movement prediction, the center position (Xo(k),Yo(k)) of the obstacle, the vehicle body yaw angle θo(k), and the velocity Vo(k) at a prediction point k (k=0, . . . , N) are predicted. In the present embodiment, the motion of the obstacle is approximated with uniform linear motion, and the center position (Xo(k),Yo(k)) of the obstacle, the vehicle body yaw angle θo(k), and the velocity Vo(k) at the prediction point k (k=0, . . . , N) are predicted as follows.

Xₒ(k)=Xₒ(k−1)+Vₒ(k−1)cos(θₒ(k−1))·Tₛ·k (211)

Yₒ(k)=Yₒ(k−1)+Vₒ(k−1)sin(θₒ(k−1))·Tₛ·k (212)

θₒ(k)=θₒ(k−1) (213)

Vₒ(k)=Vₒ(k−1) (214)

In this regard, however, (Xo(0),Yo(0)), θo(0), Vo(0) are the center position, the vehicle body yaw angle, and the velocity of the obstacle, respectively, that are acquired by the obstacle information acquisition section 110 at the present time. In the case where two or more obstacles exist, the foregoing prediction is applied to each of the obstacles. In addition, the prediction may be performed not based on uniform linear motion but based on the assumption that the obstacle moves along a traveling lane at a constant speed. Alternatively, the prediction may be performed by use of a driver model.

Next, in S230 in FIG. 5, the decision making section 230 makes a decision. In the decision making, a target action to be taken by the ego vehicle and a target lane on which the ego vehicle should travel are decided, based on the obstacle information, the road information, and the vehicle information. In the present embodiment, it is assumed that the options of the target action include lane keeping and lane changing. In addition to those, stopping, emergency stopping, and the like may be included.

In the decision making, publicly known technologies such as a finite state machine, ontology, a decision tree, reinforcement learning, and a Markov decision process are utilized. In the present embodiment, it is assumed that a finite state machine is utilized for making decision; when automatic driving starts, the target action is lane keeping; it is determined whether or not lane changing is necessary, based on the destination and the present traveling lane of the ego vehicle; then, the target action is changed to lane changing. In addition to that, it may be allowed that it is determined from movement prediction information whether or not passing by the ego vehicle is necessary and that in the case where the passing is necessary, the target action is changed to lane changing. In addition, in the case where target action is lane changing, it is also determined whether the lane is to be changed to the right lane or to the left lane. This decision is made based on, for example, the position of the passing lane and the like.

For example, in the case where the target action is lane keeping, the ego lane is the target lane. In the case where the target action is lane changing to the right, the right lane is the target lane. In this regard, however, at the instant when the ego vehicle moves across the lane line to the right lane, the target lane becomes the right lane viewed from the original lane, i.e., the ego lane after the ego vehicle has moved across the lane line to the right lane. The lane changing to the left is similar to the above.

Next, in S240 in FIG. 5, the entry-prohibition-region setting section 240 sets an entry prohibition region S. In the present embodiment, an ellipsoidal entry prohibition region is set at the center position (Xo(0), Yo(0)) of an obstacle at the prediction point k (k=0, . . . , N). The ellipsoidal equation [ξ(X,Y)=0] is expressed by the following equation.

$$ζ ( X , Y ) = 1 - \{ {( \frac{( X - {X}_{o} ( k ) ) \cdot cos {θ}_{o} ( k ) + ( Y - {Y}_{o} ( k ) ) \cdot sin {θ}_{o} ( k )}{{l}_{a}} )}^{2} + {( \frac{- ( X - {X}_{o} ( k ) ) \cdot sin {θ}_{o} ( k ) + ( Y - {Y}_{o} ( k ) ) \cdot cos {θ}_{o} ( k )}{{l}_{b}} )}^{2} \} = 0 \qquad ( 215 )$$

“la” and “lb” are the major axis and the minor axis, respectively, of the ellipse set for the obstacle; they may be changed for each prediction point k. Moreover, it is not required that the position of the ellipse coincides with the center position (Xo(k), Yo(k)) of the obstacle. Moreover, it is not required that the entry prohibition region to be set for the obstacle is ellipsoidal; it may be allowed that an entry prohibition region having an arbitrary shape is set. In the case where two or more obstacles exist, the respective entry prohibition regions are set for the obstacles.

For the sake of the safety, with regard to a possibility determination on lane changing, it is more important to reduce false positives (determining lane changing to be possible even when it is impossible) than to reduce false negatives (determining lane changing to be impossible even when it is possible). Accordingly, when the false positives in the possibility determination on lane changing are required to be reduced, it may be allowed that the entry prohibition region is expanded only when the determination is performed. As a result, at a time of the determination, the ego vehicle can hardly reach the target lane; thus, when lane changing cannot be performed with a margin, it can be determined that the lane changing is impossible, and hence the safety is raised.

Next, in S250 in FIG. 5, the target-trajectory generation section 250 solves an optimization problem expressed by the equation (101) so as to generate a target trajectory ξ. The target trajectory ξ is series data including the target position of the ego vehicle; in the present embodiment, the target trajectory ξ is series data of the vehicle-state x expressed by the equation (104).

In the case where the target action is lane keeping, the target-trajectory generation section 250 generates the target trajectory ξ (target lane keeping trajectory ξLK) for keeping the lane; in the case where the target action is lane changing, the target-trajectory generation section 250 generates the target trajectory ξ (target lane changing trajectory ξLC) for changing the lane.

Next, in S260 in FIG. 5, the determination section 260 determines whether or not lane changing is possible, based on the target lane changing trajectory ξLC. In the present embodiment, this determination is performed at the timing when the target action changes to lane changing, i.e., at a time when the lane changing starts. In this regard, however, the determination may be performed while the lane changing is continued.

When it is determined that the lane changing is possible, the target lane changing trajectory ξLC is outputted to the vehicle control section 270. When it is determined that the lane changing is impossible, the target lane keeping trajectory ξLK is outputted to the vehicle control section 270. In the present embodiment, the target lane keeping trajectory ξLK outputted at last by the determination section 260 is preliminarily stored, and then the target lane keeping trajectory ξLK to be outputted at this moment is generated based on the stored target lane keeping trajectory ξLK. In addition to that, it may be allowed that there is outputted the target lane keeping trajectory ξLK that is obtained by changing the target action to lane keeping and then solving an optimization problem again. Moreover, in the case where it is determined that lane changing is impossible and there exist a margin in the calculation time, it may be allowed to calculate the target lane changing trajectory ξLC again after changing the reference value, the weight, or the like in the optimization problem.

In the case where the target action is lane keeping, the determination section 260 performs no determination and the target lane keeping trajectory ξLK generated by the target-trajectory generation section 250 is outputted as it is.

Next, in S270 in FIG. 5, the vehicle control section 270 calculates a target value for performing steering control and vehicle-speed control so that the ego vehicle keeps track of the target trajectory ξ. In the present embodiment, a target steering angle δt, which is a target value related to steering, and a target longitudinal acceleration axt, which is a target value related to a velocity. In the present embodiment, because the target trajectory δ includes the optimal value of the target steering angle δt(k) and the optimal value of the target longitudinal acceleration axt(k) at the prediction point k (k=0, . . . , N), the target steering angle δt and the target longitudinal acceleration axt are each calculated by interpolating the respective optimal values of the target steering angle δt(k) and the target longitudinal acceleration axt(k) in the time direction in accordance with the respective control frequencies of the actuators.

Next, in S310 in FIG. 5, the actuator control section 310 controls the actuators, based on the control amount. In the present embodiment, the EPS motor 5 is controlled so that the steering angle δ keeps track of the target steering angle δt, and the power train unit 6 and a brake control unit 7 are controlled so that the longitudinal acceleration ax keeps track of the target longitudinal acceleration axt.

### <Generation Procedure for Target Trajectory>

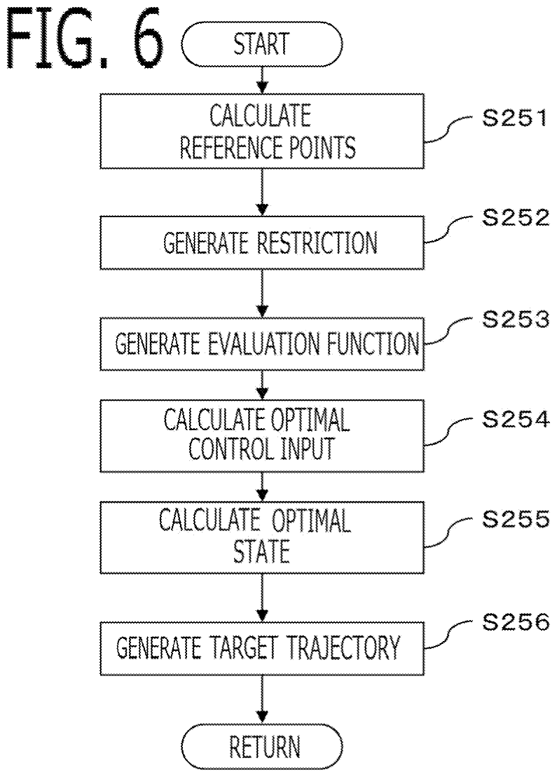

FIG. 6 is a flowchart representing a generation procedure for the target trajectory. This processing is performed in S250 in FIG. 5.

At first, in S251 in FIG. 6, reference points are calculated. The reference points is series data items on the reference position (Xr,Yr), the reference trajectory yaw angle ψr, and the reference velocity Vr, expressed every time interval Ts from the present time point 0 to the prediction-period Th future. In addition, hereinafter, the reference position (Xr(k),Yr(k)) (k=0, . . . , N) will be referred to as the reference trajectory χr.

The reference position (Xr(k),Yr(k)), the reference trajectory yaw angle ψr(k), and the reference velocity Vr(k) (k=0, . . . , N) at each time are determined as follows. At first, the reference velocity Vr(k) is determined based on the limiting speed Vl of the traveling lane and the velocity Vp of the preceding vehicle; for example, Vr(k)=Vl. In addition, it is not required that Vr(k) is a constant value in the horizon.

Next, in the case where the target action is lane keeping, the reference position (Xr(k),Yr(k)) and the reference trajectory yaw angle ψr(k) are determined, based on the X position, the Y position, and the route azimuth of the lane center, so that the ego vehicle can travel on the center of the target lane. Simultaneously, a condition is set for the relationship between the reference position (Xr(k),Yr(k)) and the reference velocity Vr(k) so that reference position (Xr(k),Yr(k)) and the reference velocity Vr(k) match with each other. In other words, the reference position (Xr(k),Yr(k)) is determined in such a way as to satisfy the two equations below.

Yᵣ(k)=lₑ(Xᵣ(k))(k=0, . . . ,N) (301)

{square root over ((Xᵣ(k)−Xᵣ(k−1))²+(Yᵣ(k)−Yᵣ(k−1))²)}=Vᵣ(k−1)·Tₛ(k=1, . . . ,N) (302)

The equation (301) is the condition for the reference position (Xr(k),Yr(k)) to exist on the function Y (=le(X)) (the equation (205)) that expresses the ego lane center; the equation (302) is the condition for the distance between the adjacent reference positions (Xr(k−1),Yr(k−1)) and (Xr(k),Yr(k)) to become equal to the moving amount of the ego vehicle during the time interval Ts. The azimuth of the ego lane center Y ((=le(X)) at the reference position (Xr(k),Yr(k)) determined in such a manner as described above is calculated, so that the reference trajectory yaw angle ψr(k) can also be determined. Hereinafter, the reference trajectory for lane keeping will be referred to as a reference lane keeping trajectory χrLK.

In the case where the target action is lane changing, for example, the present lane center and the center of the target lane are connected with each other in a continuous and smooth manner, so that a function Y (=lLC(X)) that expresses a reference trajectory (a reference lane changing trajectory χrLC) for lane changing is generated. The reference lane changing trajectory χrLC is a trajectory generated without any restriction that the vehicle does not enter the entry prohibition region, and can be referred to as a no-obstacle lane changing trajectory. For the connection, a publicly known method such as a spline curve or a fifth-order function is utilized. Then, the reference position (Xr(k),Yr(k)) is determined by use of the following equation instead of the equation (301).

Yᵣ(k)=l_{LC}(Xᵣ(k))(k=0, . . . ,N) (303)

The azimuth of the reference lane changing trajectory Y (=lLC(X)) at the reference position (Xr(k),Yr(k)) determined in such a manner as described above is calculated, so that the reference trajectory yaw angle ψr(k) can also be determined. In addition, the connection is made in such a way that there can be generated a reference lane changing trajectory χrLC with which the lane changing is completed in a target required time tLC for lane changing, for example, in such a way that transverse movement to the target lane is completed with a distance d by which the ego vehicle longitudinally moves in the target required time tLC. The distance d may be calculated either by integrating the reference velocity Vr or by multiplying the present velocity V0 by the target required time tLC. Moreover, in the case where the traveling lane is a curved lane, the connection may be made in a route coordinate system. Still moreover, in the case where it is not required to designate the target required time tLC for lane changing and the prediction time Th is sufficiently long, it may be allowed that without generating the reference lane changing trajectory χrLC, the reference position (Xr(k),Yr(k)) is determined simply by use of the following equation instead of the equation (301).

Yᵣ(k)=lₒ(Xᵣ(k))(k=0, . . . ,N) (304)

In this situation, Y=lo(X) is a function expressing the target-lane center; based on the equations (205), (206), and (207), the respective target lanes of the ego lane, the left lane, and the right lane are expressed by lo, le, ll, and lr.

The reference position (Xr(k),Yr(k)), the reference trajectory yaw angle ψr(k), and the reference velocity Vr(k) (k=0, . . . , N), calculated as described above, are adopted as the reference points.

Next, in S252 in FIG. 6, the restriction g(x,u) is set to be the same as or smaller than 0. In the present embodiment, the function g is set as follows so that the gravity center position (Xg(k), Yg(k)) at the prediction point k (k=0, . . . , N) does not enter the entry prohibition region S set in S240 and the control input u(k) falls within a specific range.

$$g ( k ) = [ \begin{matrix}ζ ( {X}_{g} ( k ) , {Y}_{g} ( k ) ) \\ {j}_{x t} ( k ) - j {H}_{x t} \\ - {j}_{x t} ( k ) + j {L}_{x t} \\ {ω}_{t} ( k ) - ω {H}_{t} \\ - {ω}_{t} ( k ) + ω {L}_{t}\end{matrix} ] ( k = 0 , … , N - 1 ) \qquad ( 305 )$$

$$g ( N ) = ζ ( {X}_{g} ( N ) , {Y}_{g} ( N ) ) \qquad ( 306 )$$

In the above equations, jHxt, jLxt, ωHt, and ωLt are the respective upper limit values or lower limit values of the control inputs. The respective upper limit values or lower limit values of the control inputs may be changed for each prediction point k. In the present embodiment, the restriction is applied only to the control input u; however, it may be allowed that in order to raise the riding comfort, the restriction is applied to the yaw rate, the lateral acceleration, or the like. Moreover, the restriction may be changed in accordance with the target action.

Next, in S253 in FIG. 6, the evaluation function J (the equation (103)) is set. In the present embodiment, the vector-valued functions h and hN related to the evaluation items are set as follows so that there can be generated the target trajectory ξ for keeping track of the reference points (the reference position (Xr(k),Yr(k)), the reference trajectory yaw angle ψr(k), and the reference velocity Vr(k) (k=0, . . . , N)), calculated by the ego vehicle in S251, and so that the control inputs are decreased at each time when the target trajectory is generated.

h=[e_{w}(k),V(k),jₜ(k),ωₜ(k)]^{T} (307)

h_{N}=[e_{w}(N),V(N)]^{T} (308)

The symbol ew(k) is a lateral deviation from the reference position (Xr(k),Yr(k)) at the prediction point k (k=0, . . . , N) and is expressed by the equation (309), by use of the reference position (Xr(k),Yr(k)) and the reference trajectory yaw angle ψr(k) at the prediction point k (k=0, . . . , N).

e_{w}(k)=cos ψᵣ(k)·(Y_{g}(k)−Yᵣ(k))−sin ψᵣ(k)·(X_{g}(k)−Xᵣ(k)) (309)

The reference values r(k) and r(N) are set as follows.

r(k)=[0,Vᵣ(k),0,0]^{T}(k=0, . . . ,N−1) (310)

r(N)=[0,Vᵣ(N)]^{T} (311)

In the above equation, Vr(k) is a reference velocity. As a result, the target-trajectory generation section can generate a target trajectory with which the ego vehicle keeps track of the reference points by means of small control inputs. In addition, it may be allowed that in order to raise the trackability to the reference points and the riding comfort, the trajectory yaw angle, the yaw rate, the longitudinal acceleration, the lateral acceleration, and the like are added to the evaluation items. Moreover, the evaluation function may be changed in accordance with the target action.

Next, in S254 in FIG. 6, the optimal control input u* is calculated by solving the evaluation function equation (103) and the optimization problem equation with restriction (101) utilizing the restriction equation (102). In the calculation of the optimal control input u*, there is utilized a publicly known means such as ACADO (Automatic Control and Dynamic Optimization) developed by the university K.U.Leuven or AutoGen, which is an automatic code generation tool for solving an optimization problem, based on C/GMRES method. In the case where ACADO or AutoGen is utilized, a temporal sequence of optimized control inputs (optimal control inputs) at the prediction point k (k=0, . . . , N−1) is outputted. That is to say, the output in S254 is the equation (312).

$${u}^{*} = [ {u}^{*} ( 0 ) … {u}^{*} ( N - 1 ) ] = [ \begin{matrix}{j}_{xt}^{*} ( 0 ) & … & {j}_{xt}^{*} ( N - 1 ) \\ {w}_{t}^{*} ( 0 ) & … & {ω}_{t}^{*} ( N - 1 )\end{matrix} ] \qquad ( 312 )$$

In the above equation, jxt*(k) and ωt*(k) (k=0, . . . , N−1) are the optimal value of the target longitudinal jerk and the optimal value of the target steering angular speed, respectively. In addition, as the solution, there may be adopted a value with which the evaluation function becomes smaller than a predetermined threshold value; in the case where the evaluation function does not become smaller than the predetermined threshold value within the number of predetermined repeated times, a value with which the evaluation function is minimized within the number of predetermined repeated times may be adopted as the solution.

Next, in S255 in FIG. 6, an optimal state x* is calculated. In the calculation of the optimal state x*, the temporal sequence (optimal state) x* of the vehicle-states optimized at the prediction point k (k=0, . . . , N) is calculated by use of the optimal control input u* and the vehicle model f. Accordingly, the output in S255 is the equation (313).

$${x}^{*} = [ {x}^{*} ( 0 ) … {x}^{*} ( N ) ] = [ \begin{matrix}{X}_{g}^{*} ( 0 ) & … & {X}_{g}^{*} ( N ) \\ {Y}_{g}^{*} ( 0 ) & … & {Y}_{g}^{*} ( N ) \\ {θ}^{*} ( 0 ) & … & {θ}^{*} ( N ) \\ {β}^{*} ( 0 ) & … & {β}^{*} ( N ) \\ {γ}^{*} ( 0 ) & … & {γ}^{*} ( N ) \\ {V}^{*} ( 0 ) & … & {V}^{*} ( N ) \\ {a}_{x}^{*} ( 0 ) & … & {a}_{x}^{*} ( N ) \\ {a}_{xt}^{*} ( 0 ) & … & {a}_{xt}^{*} ( N ) \\ {δ}^{*} ( 0 ) & … & {δ}^{*} ( N ) \\ {δ}_{t}^{*} ( 0 ) & … & {δ}_{t}^{*} ( N )\end{matrix} ] \qquad ( 313 )$$

In the above equation, Xg*(k), Yg*(k), θ*(k), β(k), γ*(k), V*(k), ax*(k), axt*(k), δ*(k), and δt*(k) are each the optimal values of the gravity center position, the vehicle body yaw angle, the sideslip angle, the yaw rate, the velocity, the longitudinal acceleration, the target longitudinal acceleration, the steering angle, and the target steering angle, respectively.

Next, in S256 in FIG. 6, the target trajectory is generated. The target trajectory ξ is generated based on the optimal state x* and the optimal control input u*. In the case where based on information on the target trajectory ξ the determination section 260 determines whether or not lane changing is possible, it is only necessary that the target trajectory includes an optimal gravity center position (Xg*, Yg*); in the case where the determination section 260 determines whether or not lane changing is possible, further based on the maneuver of steering, it is only necessary that the target trajectory further includes the optimal steering angle δ* and the optimal target steering angular speed ωt* that are variables related to the steering. In the present embodiment, the optimal state x* is adopted as the target trajectory ξ. Accordingly, the output in S256 is the equation (314).

ξ=[x*(0) . . . x*(N)] (314)

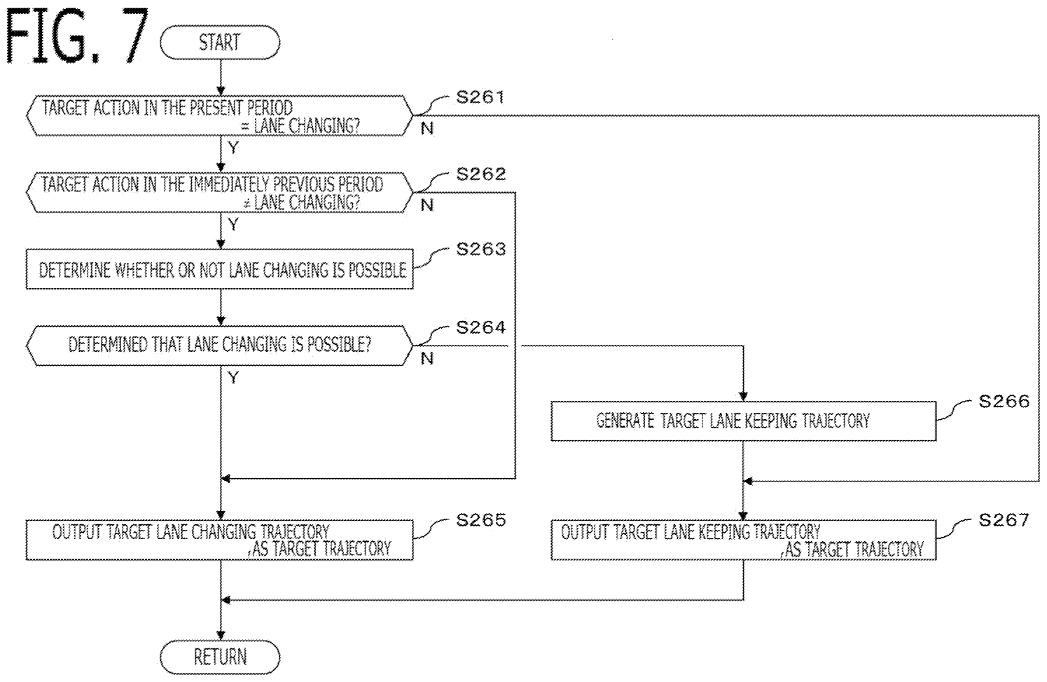

In addition, the target trajectory ξ at a time when the target action is lane keeping will be referred to as the target lane keeping trajectory ξLK, and the target trajectory at a time when the target action is lane changing will be referred to as the target lane changing trajectory ξLC. As explained in S251, when the target action differs, at least the reference trajectory χr differs. In this regard, however, it may be allowed that in addition to that, the item or the value of the restriction is changed in S252 or the item or the value of the evaluation function is changed in S253.

<Procedure for Determination on Whether or Not Lane Changing is Possible> FIG. 7 is a flowchart representing a procedure for a determination on whether or not lane changing is possible. This processing is performed in S260 in FIG. 5.

At first in S261 in FIG. 7, it is determined whether or not the target action in the present period is lane changing. In the case where it is determined that the target action in the present period is lane changing, the processing in S262 is performed. In the case where it is determined that the target action in the present period is not lane changing, the processing in S267 is performed.

In the case where in S261 in FIG. 7, it is determined that the target action in the present period is lane changing, it is determined in S262 in FIG. 7 whether or not the target action in the immediately previous period has been lane changing. In the case where it is determined that the target action in the immediately previous period has been lane changing, the processing in S263 is performed. In the case where it is determined that the target action in the immediately previous period has not been lane changing, the processing in S265 is performed.

In the case where in S262 in FIG. 7, it is determined that the target action in the immediately previous period has been lane changing, i.e., in the case where the lane changing is started, it is determined in S263 in FIG. 7 whether or not the lane changing is possible. Whether or not the lane changing is possible is determined based on the target lane changing trajectory ξLC generated in S250 in FIG. 5.

Hereinafter, a determination method based on the target lane changing trajectory ξLC will be explained. In the present embodiment, the determination is performed based on the attainment degree of the target lane changing trajectory ξLC to the target lane.

In the determination based on the attainment degree, in the case where the target required time tLC for lane changing and the prediction time Th are equal to each other, whether or not the lane changing is possible is determined, for example, based on whether or not the absolute value of the lateral deviation ew*(N) between the target lane and the last point (Xg*(N),Yg*(N)) of the target lane changing trajectory ξLC falls within a determination value ε1. In the case where the absolute value is within the determination value ε1, the target lane can be reached in the target required time tLC and hence it is determined that the lane changing is possible; in the case where the absolute value is not within the determination value ε1, the target lane cannot be reached in the target required time tLC and hence it is determined that the lane changing is impossible. The determination value ε1 is set, for example, either to a value that is 10% of the lane width of the target lane or to the half of the lane width.

In the case where the target required time tLC for lane changing is shorter than the prediction time Th, the determination is performed based on whether or not the absolute value of the lateral deviation ew*(k) between the gravity center position (Xg*(k),Yg*(k)) of the target lane changing trajectory ξLC and the reference position (Xr(k),Yr(k)) of the reference lane changing trajectory χrLC at the prediction point k corresponding to the target required time tLC falls within the determination value ε1.

In the case where the target required time tLC for lane changing is longer than the prediction time Th, whether or not the lane changing is possible is determined based on whether or not the absolute value of the lateral deviation ew*(N) between the last point (Xg*(N),Yg*(N)) of the target lane changing trajectory ξLC and the last point (Xr(N),Yr(N)) of the reference lane changing trajectory χrLC falls within the determination value ε1.

In addition, it may be allowed that the determination is performed based on not the attainment degree but the degree of divergence between the reference lane changing trajectory χrLC and the target lane changing trajectory ξLC. That is to say, it may be allowed that the determination is performed based on how much consideration of an entry prohibition region makes the target lane changing trajectory ξLC separated from the lane changing trajectory without consideration of the entry prohibition region. In the determination based on the degree of divergence, whether or not the lane changing is possible is determined, for example, based on whether or not the maximum value or the root mean square of the absolute value of the lateral deviation ew*(k) from the reference lane changing trajectory χrLC is within a determination value ε2. In the case where the maximum value or the root mean square is within the determination value ε2, the divergence is small; thus, it is determined that the lane changing is possible. In the case where the maximum value or the root mean square is larger than the predetermined value, the divergence is large; thus, it is determined that the lane changing is impossible. The setting method for the determination value ε2 is the same as that for the determination value ε1.

Next, in S264 in FIG. 7, it is determined whether or not it has been determined in S263 that the lane changing is possible. In the case where it is determined that it has been determined that the lane changing is possible, the processing in S265 is performed. In the case where it is determined that it has been determined that the lane changing is impossible, the processing in S266 is performed.

In the case where it is determined in S264 in FIG. 7 that it has been determined that the lane changing is possible, the target lane changing trajectory ξLC is outputted, as the target trajectory in S265 in FIG. 7.

In the case where it is determined in S264 in FIG. 7 that it has been determined that the lane changing is impossible, the target lane keeping trajectory ξLK is generated in S266 in FIG. 7.

The target lane keeping trajectory ξLK is generated as follows: for example, the target lane keeping trajectory ξLK outputted at the last time in S267 is preliminarily stored; the stored target lane keeping trajectory ξLK is time-interpolated by the amount corresponding to a time elapsed from the time point of the storage; then, coordinate transformation is applied to the gravity center position and the vehicle body yaw angle (Xg*(k),Yg*(k), θ*(k)) of the target lane keeping trajectory ξLK time-interpolated by the time corresponding to a moving amount from the time point of the storage.

Next, in S267 in FIG. 7, the target lane keeping trajectory ξLK is outputted, as the target trajectory ξ.

### Example 1 of Determination Based on Attainment Degree

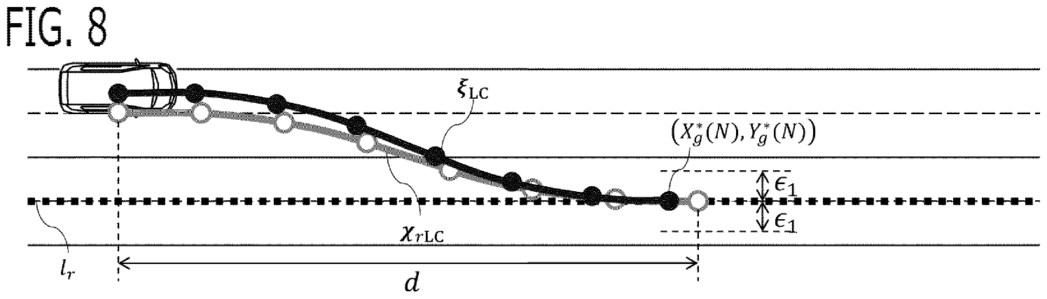

FIG. 8 is a schematic chart representing a method of performing a determination based on an attainment degree at a time when the target required time tLC for lane changing and the prediction time Th are equal to each other. FIG. 8 is a scene at a time when the target action changes to lane changing and the target lane changes to the right lane. In addition, FIG. 8 also represents a scene at a time when the target lane changing trajectory ξLC is generated for the reference lane changing trajectory χrLC. Because the target required time tLC and the prediction time Th are equal to each other, whether or not the lane changing is possible is determined based on whether or not the lateral deviation ew*(N) between the target lane and the last point (Xg*(N),Yg*(N)) of the target lane changing trajectory ξLC is the same as or smaller than the determination value ε1. In the case of FIG. 8, because the lateral deviation ew*(N) is the same as or smaller than the determination value ε1, it is determined that the lane changing is possible.

### Example 2 of Determination Based on Attainment Degree

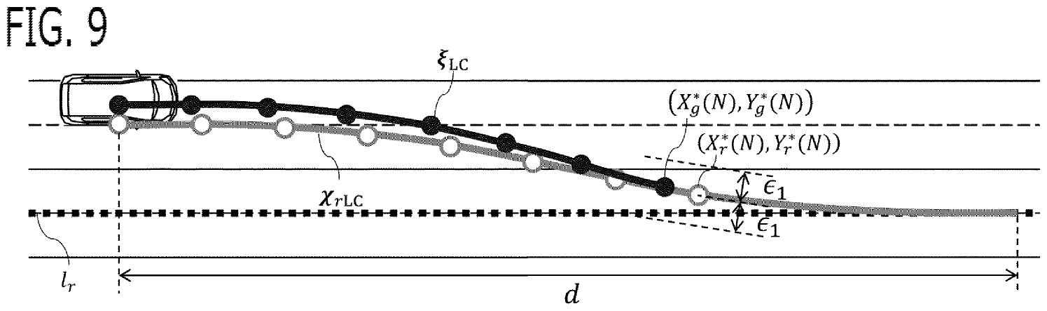

FIG. 9 is another schematic chart representing a method of performing a determination based on an attainment degree at a time when the target required time tLC for lane changing is larger than the prediction time Th. FIG. 9 is a scene at a time when, as is the case with FIG. 8, the target action changes to lane changing, the target lane changes to the right lane, and then the target lane changing trajectory ξLC is generated for the reference lane changing trajectory χrLC. Because the target required time tLC is larger than the prediction time Th, whether or not the lane changing is possible is determined based on whether or not the lateral deviation ew*(N) between the last point (Xg*(N),Yg*(N)) of the reference lane changing trajectory χrLC and the last point (Xg*(N),Yg*(N)) of the target lane changing trajectory ξLC is the same as or smaller than the determination value U. In the case of FIG. 9, because the lateral deviation ew*(N) is the same as or smaller than the determination value ε1, it is determined that the lane changing is possible.

### Example 3 of Determination Based on Attainment Degree

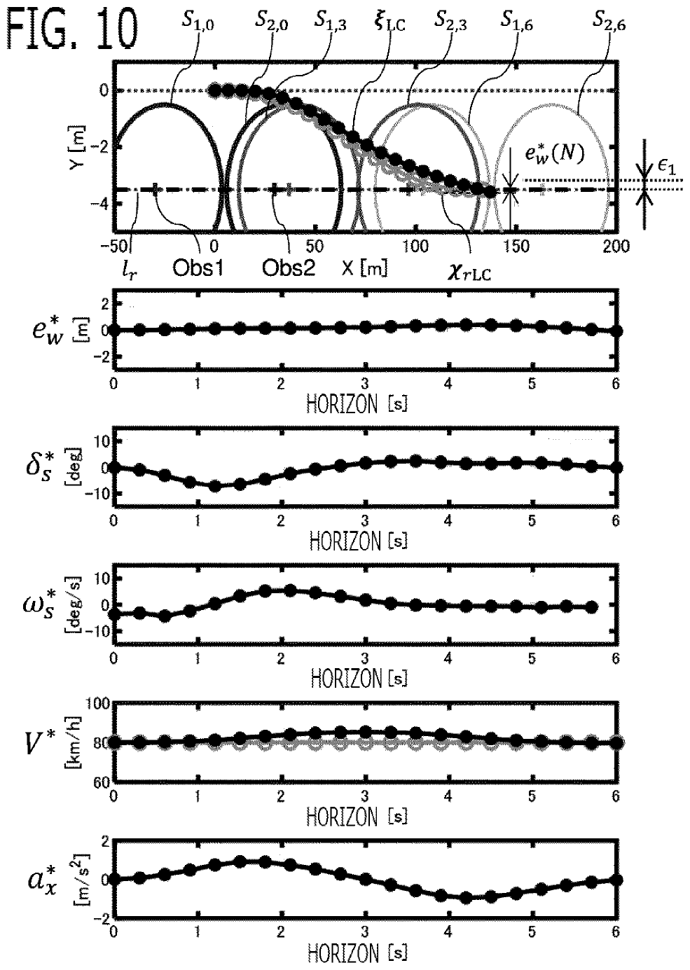

FIG. 10 is a set of another schematic charts representing a method of performing a determination based on an attainment degree in a scene where an obstacle exists. FIG. 10 is a scene at a time when, as is the case with FIG. 8, the target action changes to lane changing, the target lane changes to a right lane lr, and then the target lane changing trajectory ξLC is generated for the reference lane changing trajectory χrLC. In this regard, however, it is assumed that the ego vehicle exists at (X,Y)=(0, 0)m at a horizon 0 s and the velocity is 80 km/h. Moreover, an obstacle 1 exists at the rear side (X,Y)=(−30, −3.5)m of the right lane; an obstacle 2 exists at the front side (X,Y)=(30, −3.5)m of the right lane; each of the obstacles is moving in the same direction as the ego vehicle at a speed of 80 km/h. In addition, each of the target required time tLC and the prediction time Th is 6 sec. Moreover, in order to reduce false positives, only when whether or not lane changing is possible is determined, the entry prohibition region is expanded 1.05 times as large as that at other situations. Still moreover, it is assumed that the determination value ξ1 is 10% of the lane width of 3.5 m, i.e., 0.35 m.

The dots and solid line in each of the centers of the charts in FIG. 10 are plots of each of the respective vehicle-states on the target trajectory ξ; the charts are the gravity center position (Xg*(k),Yg*(k)) of the ego vehicle, the lateral deviation ew*(k), a steering-wheel angle ξs*, a steering-wheel angular speed ωs*, the velocity V*, and the longitudinal acceleration ax* in sequence from top to bottom. The steering-wheel angle is obtained by multiplying the steering angle by the gear ratio. In each of the plots after and including the second one in FIG. 10, the abscissa denotes a horizon. In each of the first and fifth plots from the top in FIG. 10, the hollow dots denote the reference lane changing trajectory χrLC and the solid line denotes the reference velocity Vr(k). In the topmost plot in FIG. 10, the cross existing at (X,Y)=(−30, −3.5)m is the center position of the obstacle 1 at the horizon 0 s; the cross existing at (X,Y)=(30, −3.5)m is the center position of the obstacle 2 at the horizon 0 s. Moreover, in the same plot, S expresses the entry prohibition region of the obstacle at each of the horizons; the first numeral and the second numeral in the subscripts expresses the obstacle number and the horizon, respectively.

In FIG. 10, because the lateral deviation ew*(N) between the target lane and the last point (Xg*(N),Yg*(N)) of the target lane changing trajectory ξLC is substantially 11/M, i.e., smaller than the determination value ξ1, the target lane can be reached; thus, it is determined that the lane changing is possible.

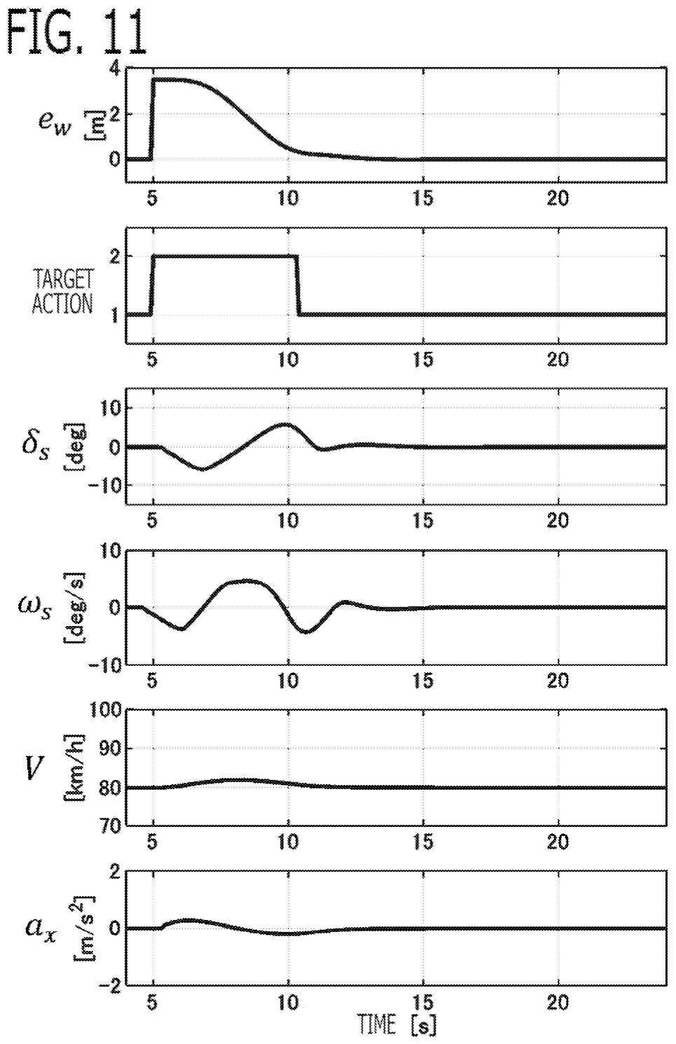

It will be verified whether or not the determination in FIG. 10 that the lane changing is possible has actually been correct. FIG. 11 is a set of charts obtained by plotting the motion of the ego vehicle at a time when the lane changing is performed as plotted in FIG. 10.

FIG. 11 represents the lateral deviation ew between the ego vehicle and the target lane, the target action, the steering-wheel angle δs, the steering-wheel angular speed ωs, the velocity V, and the longitudinal acceleration ax in sequence from top to bottom. In this regard, however, “1” and “2” in the target action represent lane keeping and lane changing, respectively.

In the target action in FIG. 11, the lane changing has been performed in the horizons from 5 s through 10.5 s, i.e., the lane changing has been completed in the time close to the target required time tLC of 6 s. Moreover, the steering-wheel angle δs has been changed in such a way that at first, the steering wheel is turned to the right and then is returned, and, after that, the steering wheel is turned to the left and is then returned—the typical pattern at a time when lane changing to the right is performed; thus, it can be said that smooth lane changing has been performed. Accordingly, it can be said that the determination result indicating that the lane changing in the scene in FIG. 10 is possible has been appropriate.

In FIG. 10, there will be considered the case where as is the case with JP 6569186 B, the trajectory generation and the interference determination are separately performed. In FIG. 10, the entry prohibition region of the obstacle 1 at the horizon 0 s is extended to the front side of the gravity center of the ego vehicle; thus, when the ego vehicle continues changing the lane at a constant speed, the ego vehicle enters the entry prohibition region of the obstacle 1. Actually, the last point (the reference position at the horizon 6 s) of the reference lane changing trajectory χrLC generated by predicting that the ego vehicle moves at a constant speed has entered the entry prohibition region S1,6 of the obstacle 1 at the horizon 6 s. Accordingly, when as the prior art, the trajectory generation and the interference determination are performed separately, it is determined that the lane changing is impossible.

In contrast, in the case where as the present embodiment, the target lane changing trajectory is generated with restriction of an entry prohibition region, there can be generated an trajectory on which as in FIG. 10, lane changing is performed while accelerating the ego vehicle in order not to enter the entry prohibition region. Accordingly, in the situation that when the ego vehicle accelerates or decelerates, the lane changing can be performed without interfering with an obstacle, it can correctly be determined that the lane changing is possible; thus, the comfortability for the drier is raised.

### Example 4 of Determination Based on Attainment Degree

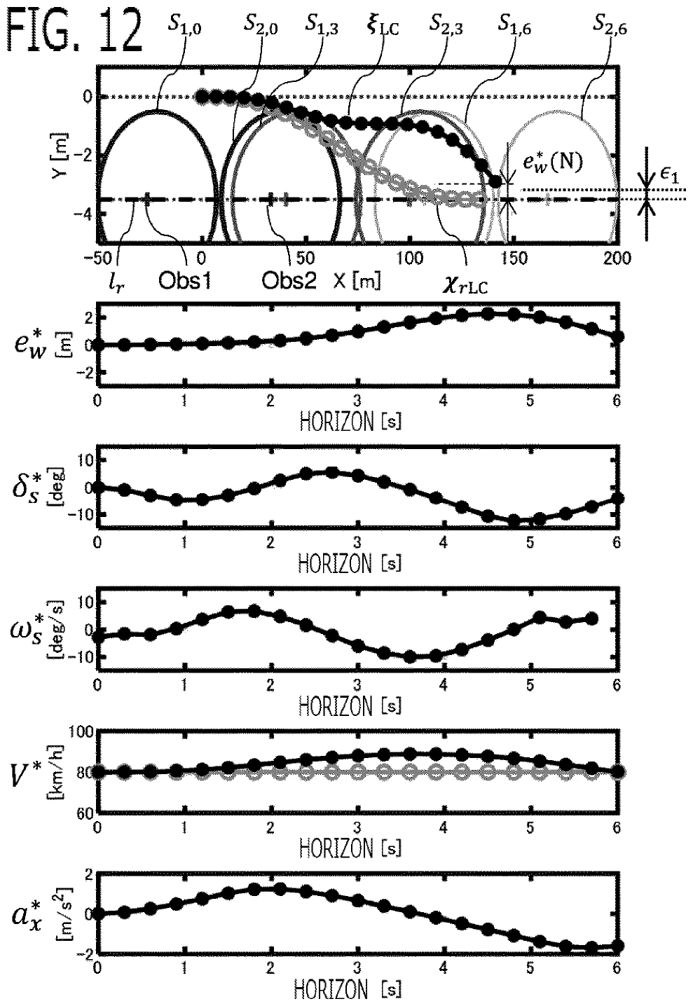

FIG. 12 is a set of another schematic charts representing a method of performing a determination based on an attainment degree in a scene where an obstacle exists. FIG. 12 represents a scene similar to that in FIG. 10; however, each of the obstacles 1 and 2 is situated at a position that is 4 m more toward the front in the traveling direction than the position in FIG. 10. The explanation for FIG. 11 is the same as that for FIG. 10.

The gravity center position (Xg*(k),Yg*(k)) of the target lane changing trajectory ξLC in FIG. 12 suggests that after starting to move toward the target lane, the ego vehicle once travels along the target lane around at Y=−1/M and then moves toward the target lane again. The reason for that is because the obstacle 1 exists closer to the ego vehicle than that is in FIG. 10, no sufficient inter-vehicle distance can be secured by the acceleration till the horizon 6 s and hence the ego vehicle cannot directly reach the target lane. Then, because the lateral deviation ew*(N) between the target lane and the last point (Xg*(N),Yg*(N)) of the target lane changing trajectory ξLC is substantially 0.6 m, i.e., not the same as or smaller than the determination value ε1, the target lane cannot be reached; thus, it is determined that the lane changing is impossible.

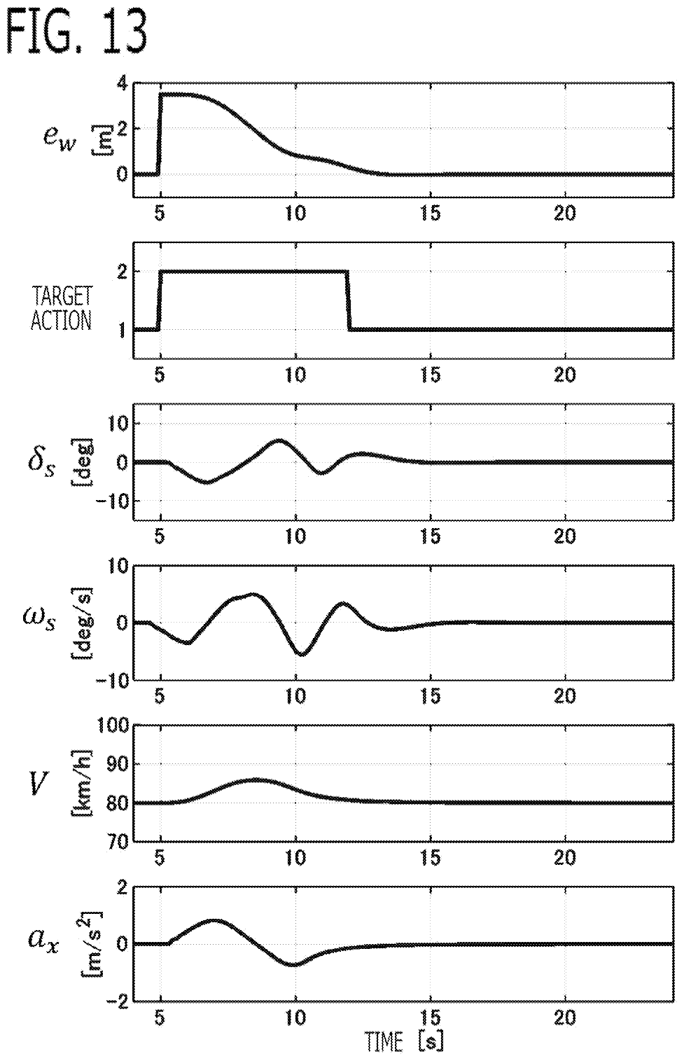

It will be verified whether or not the determination in FIG. 12 that the lane changing is possible has actually been correct. FIG. 13 is a set of charts obtained by plotting the motion of the ego vehicle at a time when the lane changing is performed as plotted in FIG. 12. The explanation for FIG. 12 is the same as that for FIG. 11.

FIG. 13 suggests that the target action is lane changing in the period from 5 through 12 s and it took longer time by substantially is than the target required time tLC of 6 s. Moreover, the lateral deviation ew from the target lane suggests that the ego vehicle has once travelled along the target lane around at 0.7 m. Still moreover, the change in the steering-wheel angle δs suggests that the number of steering changes increased by 1 from that in FIG. 11. From these facts, it can be said that in comparison with FIG. 11, unsmooth and unnatural lane changing has been performed. This kind of unnatural lane changing may give uneasy feeling to the drivers of the ego vehicle and the neighboring vehicle or may cause an accident. Accordingly, it can be said that the determination result indicating that the lane changing in the scene in FIG. 12 is impossible has been appropriate.

### Summary of Embodiment 1

Because in such a configuration, the trajectory is generated while considering an entry prohibition region, it is made possible that in a situation that when the ego vehicle accelerates or decelerates, lane changing can be performed, it is correctly determined that the lane changing is possible; thus, the comfortability for the driver is raised.

### Embodiment 2

In Embodiment 1, whether or not lane changing is possible is determined based on the attainment degree of the target lane changing trajectory ξLC to the target lane or based on the degree of divergence between the reference lane changing trajectory χrLC and the target lane changing trajectory ξLC; furthermore, whether or not lane changing is possible may be determined based also on the maneuver of steering for the target lane changing trajectory ξLC. As a result, it is made possible that in the case where although the target lane can physically be reached, unnatural steering should be performed, it is determined that the lane changing is impossible; thus, the safety and the comfortability are raised.

Hereinafter, Embodiment 2 will be explained. The explanation therefor that overlaps with the explanation for Embodiment 1 will be omitted here. The difference between Embodiment 1 and Embodiment 2 is only S263 in FIG. 7.

<Procedure for Determination on Whether or Not Lane Changing is Possible> The step S263 in FIG. 7 according to Embodiment 2 will be explained. At first, as is the case with Embodiment 1, the attainment degree of the target lane changing trajectory ξLC to the target lane is evaluated. In other words, it is determined whether or not the absolute value of the lateral deviation ew*(k) is within the determination value ε1.

Next, the maneuver of the steering angle δ* on the target lane changing trajectory ξLC is evaluated. In the typical steering pattern in which in the case where no obstacle exists, lane changing to the right is performed, when at first, the steering wheel is turned to the right and then is returned, and, after that, the steering wheel is turned to the left and then is returned, the steering is performed twice. In this case, the number of steering changes is the number of changes in the steering direction. Accordingly, whether or not smooth and natural lane changing is possible can be determined based on whether or not the number of steering changes in the steering angle δ* on the target lane changing trajectory ξLC is the same as or smaller than 2. The number of steering changes may be calculated, for example, based on the number of peaks of the steering angle δ*. Alternatively, it may be allowed that the steering angular speed ω* is calculated by time-differentiating the steering angle δ* and then the number of steering changes is calculated from the number of zero-crossings of the steering angular speed ω*. Moreover, it may be allowed that after performing smoothing processing for preventing minute steering from being counted, the number of steering changes is calculated. Then, it is determined whether or not the number of steering changes is the same as or smaller than 2. In addition, in the case where lane changing is performed at a curve, it may be allowed that after subtracting a norm steering angle δn from the δ* in order to eliminate the effect of a road curvature from the steering pattern, the number of steering changes is calculated. As a result, determination independent of the road curvature can be realized. In addition, the norm steering angle δn(k) of each of the horizons is calculated as follows, by use of, for example, a stationary two-wheel model.

$${δ}_{n} ( k ) = \frac{1}{( 1 + A \cdot {{V}_{r} ( k )}^{2} )} \cdot \frac{{V}_{r} ( k )}{l} \cdot κ ( k ) \qquad ( 401 )$$

In the above equation, A is a stability factor, l is a wheelbase, κ(k) is the curvature of the reference lane changing trajectory χrLC at the prediction point k.

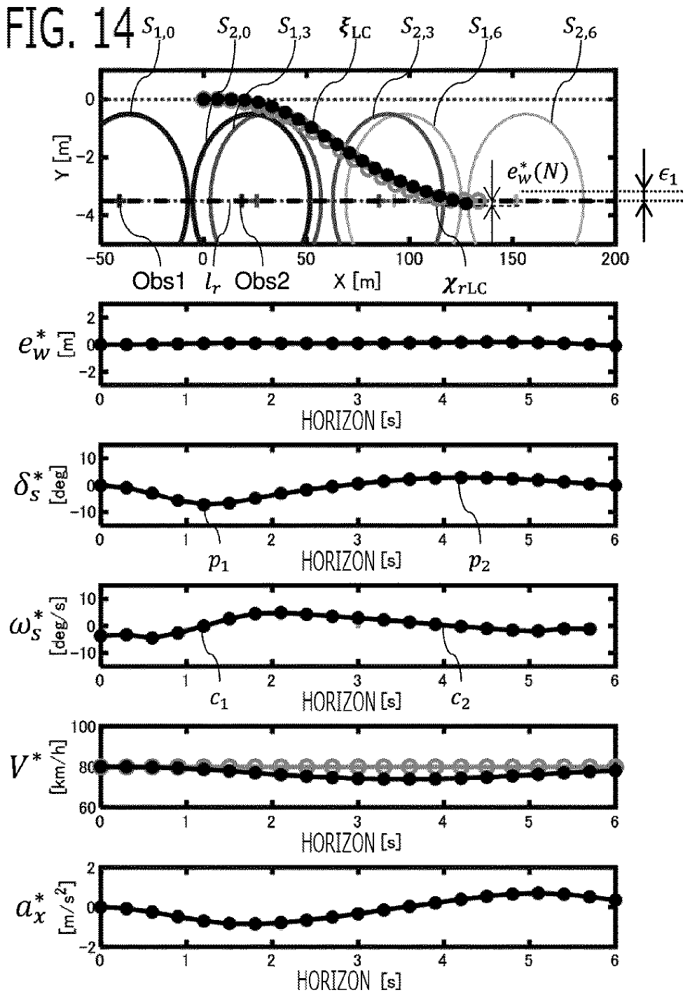

Next, in the case where the absolute value of the lateral deviation ew*(k) is within the determination value ε1 and the number of steering changes is the same as or smaller than 2, it is determined that the lane changing is possible. In all cases other than the above case, it is determined that the lane changing is impossible.

<Example 1 Of Determination Based on The Number of Steering Changes> FIG. 14 is a set of schematic charts representing a method of performing a determination based on the number of steering changes in a scene where an obstacle exists. FIG. 14 represents a scene similar to that in FIG. 10; however, each of the obstacles 1 and 2 is situated at a position that is 10 m more toward the rear in the traveling direction than the position in FIG. 10. The explanation for FIG. 14 is the same as that for FIG. 10.

At first, the attainment degree of the target lane changing trajectory ξLC to the target lane is evaluated. In FIG. 14, because the lateral deviation ew*(N) between the target lane and the last point (Xg*(N),Yg*(N)) of the target lane changing trajectory ξLC is substantially 0.1/M, i.e., smaller than the determination value ε1, it is determined that the absolute value of the lateral deviation ew*(k) is within the determination value ε1.

Next, the number of steering changes on the target lane changing trajectory ξLC is evaluated. In FIG. 14, the steering-wheel angle δs* on the target lane changing trajectory ξLC takes two extreme values at P1 and P2. Accordingly, the number of steering changes is 2. Actually, the steering pattern of the steering-wheel angle δs* is a typical pattern in which steering is performed twice, i.e., the steering wheel is turned to the right and then returned, and, after that, the steering wheel is turned to the left and then returned. Then, because the number of steering changes is 2, it is determined that the number of steering changes is the same as or smaller than 2.

Next, because the absolute value of the lateral deviation ew*(k) is within the determination value ε1 and the number of steering changes is the same as or smaller than 2, it is determined that the lane changing is possible. In addition, in the present embodiment, the number of steering changes is calculated based on the number of the extreme values of the steering-wheel angle δs*;

however, the number of zero-crossings of the steering-wheel angular speed ωs* may be evaluated. In FIG. 14, the steering-wheel angular speed cos* performs zero-crossing twice, i.e., zero-crossing at c1 and c2. Accordingly, also in the case where the number of steering changes is evaluated based on the number of zero-crossings, the number of steering changes is 2.

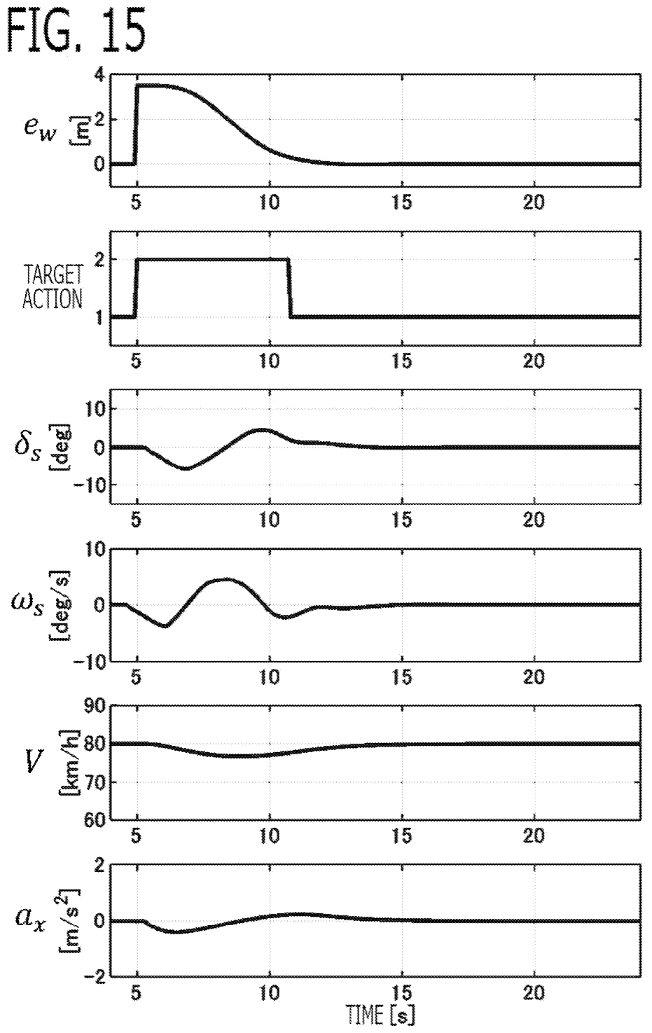

It will be verified whether or not the determination in FIG. 14 that the lane changing is possible has actually been correct. FIG. 15 is a set of charts obtained by plotting the motion of the ego vehicle at a time when the lane changing is performed as plotted in FIG. 14. The explanation for FIG. 15 is the same as that for FIG. 11.

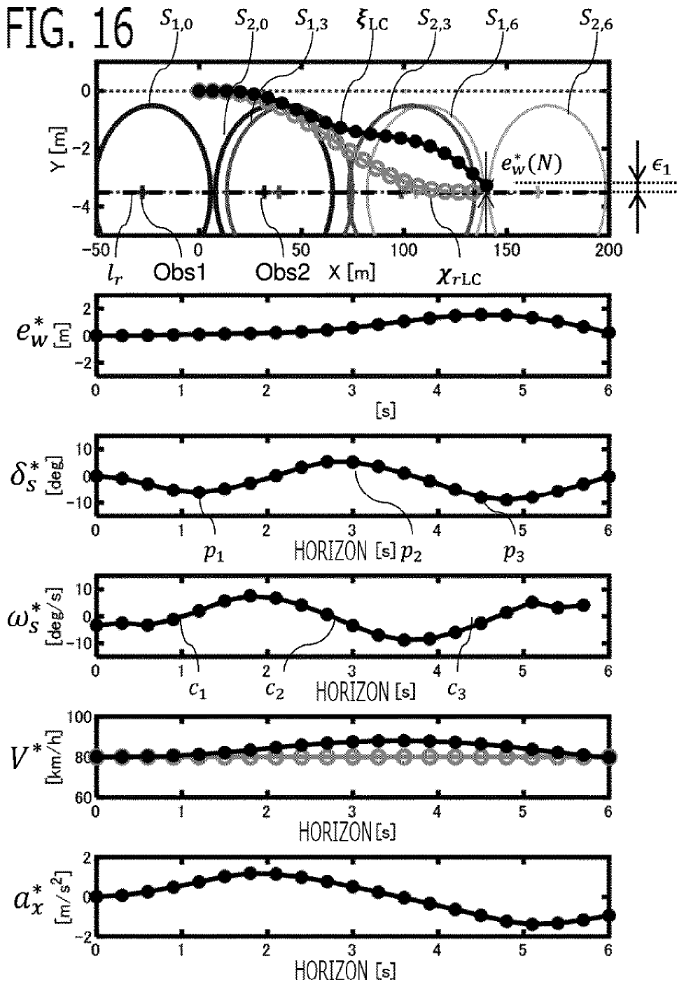

In the target action in FIG. 15, the lane changing has been performed in the horizons from 5 s through 10.7 s, i.e., the lane changing has been completed in the time close to the target required time tLC of 6 s. Moreover, the steering-wheel angle δs has been changed in such a way that at first, the steering wheel is turned to the right and then is returned, and, after that, the steering wheel is turned to the left and is then returned—the typical pattern at a time when lane changing to the right is performed; thus, it can be said that smooth lane changing has been performed. Accordingly, it can be said that the determination result indicating that the lane changing in the scene in FIG. 14 is possible has been appropriate.

<Example 2 Of Determination Based on The Number of Steering Changes> FIG. 16 is a set of another schematic charts representing a method of performing a determination based on the number of steering changes in a scene where an obstacle exists. FIG. 16 represents a scene similar to that in FIG. 10; however, each of the obstacles 1 and 2 is situated at a position that is 2.5 m more toward the front in the traveling direction than the position in FIG. 10. The explanation for FIG. 16 is the same as that for FIG. 10.

At first, the attainment degree of the target lane changing trajectory ξLC to the target lane is evaluated. In FIG. 16, because the lateral deviation ew*(N) between the target lane and the last point (Xg*(N),Yg*(N)) of the target lane changing trajectory ξLC is substantially 0.2 m, i.e., smaller than the determination value ε1, it is determined that the absolute value of the lateral deviation ew*(k) is within the determination value ε1.

Next, the number of steering changes on the target lane changing trajectory ξLC is evaluated. In FIG. 16, the steering-wheel angle δs* on the target lane changing trajectory ξLC takes three extreme values at P1, P2, and P3. Accordingly, the number of steering changes is 3. Actually, in the steering pattern of the steering-wheel angle δs*, the number of steering times is 3, i.e., larger than that in FIG. 14 by 1. Then, because the number of steering changes is 3, it is determined that the number of steering changes is not the same as or smaller than 2.

Next, because the condition that the absolute value of the lateral deviation ew*(k) is within the determination value ε1 and the number of steering changes is the same as or smaller than 2 is not satisfied, it is determined that the lane changing is impossible.

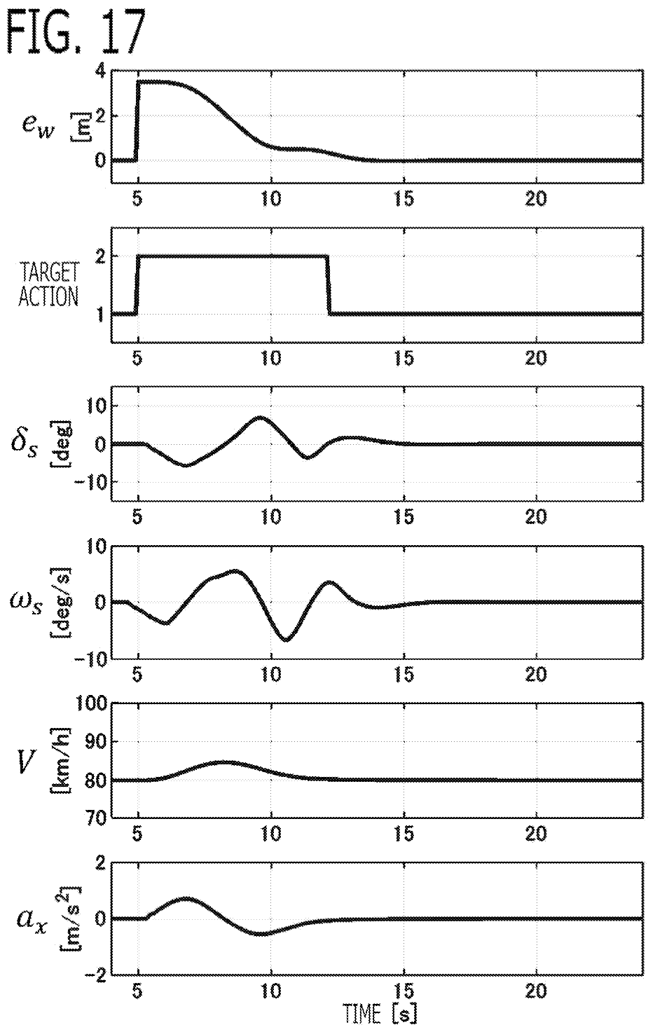

It will be verified whether or not the determination in FIG. 16 that the lane changing is impossible has actually been correct. FIG. 17 is a set of charts obtained by plotting the motion of the ego vehicle at a time when the lane changing is performed as plotted in FIG. 16. The explanation for FIG. 17 is the same as that for FIG. 11.

FIG. 17 suggests that the target action is lane changing in the period from 5 through 12 s and it took longer time by substantially is than the target required time tLC of 6 s. Moreover, the lateral deviation ew from the target lane suggests that the ego vehicle has once travelled along the target lane around at 0.5 m. Still moreover, the change in the steering-wheel angle δs suggests that the number of steering changes increased by 1 from that in FIG. 15. From these facts, it can be said that in comparison with FIG. 15, unsmooth and unnatural lane changing has been performed. This kind of unnatural lane changing may give uneasy feeling to the drivers of the ego vehicle and the neighboring vehicle or may cause an accident. Accordingly, it can be said that the determination result indicating that the lane changing in the scene in FIG. 16 is impossible has been appropriate.

In contrast, when as in Embodiment 1, whether or not lane changing is possible is determined based on only the attainment degree, it is determined that the lane changing is possible in the scene in FIG. 16. Therefore, when based also on the number of steering changes, determination on whether or not lane changing is possible is performed, it is made possible that in the case where although the target lane can physically be reached, unnatural steering should be performed, it is determined that the lane changing is impossible; thus, the safety and the comfortability are raised.

<Summary of Embodiment 2> In such a configuration, because determination on whether or not lane changing is possible is performed based also on the maneuver of steering on the target lane changing trajectory, it is made possible that in the case where although the target lane can physically be reached, unnatural steering should be performed, it is determined that the lane changing is impossible; thus, the safety and the comfortability are raised.

Embodiment 3. In Embodiment 1, when it is determined that lane changing is impossible, the target lane keeping trajectory ξLK is generated based on the stored target lane keeping trajectory ξLK; however, it may be allowed that the target lane keeping trajectory ξLK is generated by solving an optimization problem again. As a result, a safer target lane keeping trajectory ξLK can be generated. This is because in the case where the situation at a time point when the target lane keeping trajectory ξLK has been stored and the present situation are largely different from each other, it is inappropriate to utilize the stored target lane keeping trajectory ξLK. The case where the situation differs largely is, for example, the case where the storage has been made 1 s or more time earlier, the case where the number of obstacles changes after the time when the storage has made, or the like.

Hereinafter, Embodiment 3 will be explained. The explanation therefor that overlaps with the explanation for Embodiment 1 will be omitted here. The difference between Embodiment 1 and Embodiment 3 is only S266 in FIG. 7.

<Procedure for Determination on Whether or Not Lane Changing is Possible> The step S266 in FIG. 7 according to Embodiment 3 will be explained. In the case where it is determined in S264 in FIG. 7 that it has been determined that the lane changing is impossible, the target lane keeping trajectory ξLK is generated in S266 in FIG. 7.

In the present embodiment, in S266 in FIG. 7, the target action is changed to lane keeping, the target lane is changed to the original lane, and then S250 in FIG. 5 is performed again; that is to say, the target lane keeping trajectory ξLK is generated by solving an optimization problem again.

<Summary of Embodiment 3> In such a configuration, even when the situation at a time point when the target lane keeping trajectory has been stored and the present situation are largely different from each other, a safe target lane keeping trajectory ξLK can be generated.

Embodiment 4. In Embodiment 1, when it is determined that lane changing is impossible, the target lane keeping trajectory ξLK is immediately generated; however, when there exist a margin in the calculation time, it may be allowed that the target lane changing trajectory ξLC is generated again by changing the optimization problem. As a result, for example, in the case where lane changing becomes possible by slightly relaxing the restriction on the control inputs, it can be determined that the lane changing is possible; thus, because the opportunity for the lane changing is hardly missed, the comfortability for the drier is raised.

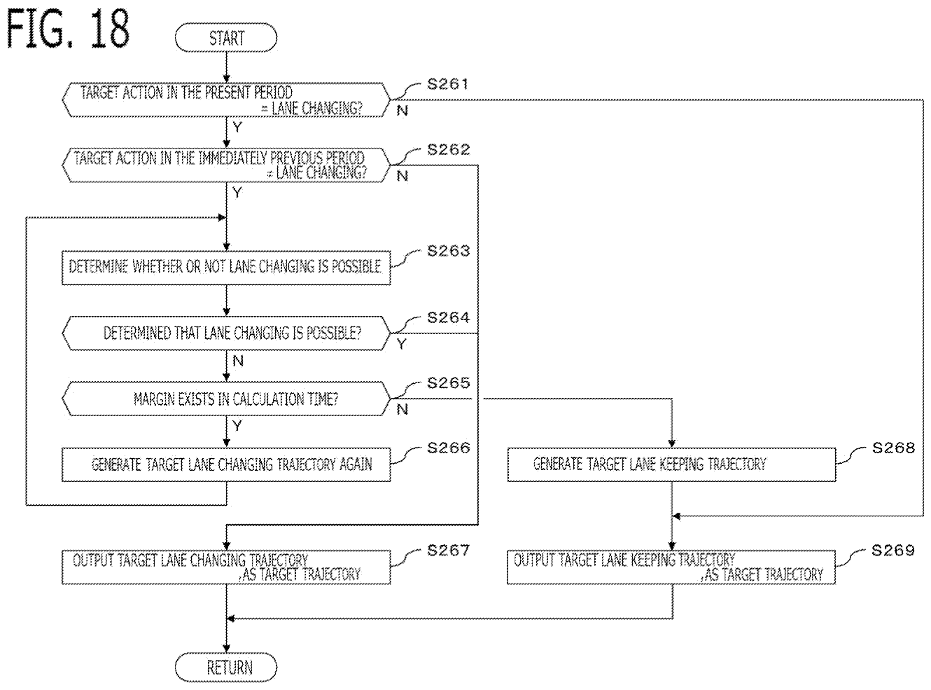

Hereinafter, Embodiment 4 will be explained. The explanation therefor that overlaps with the explanation for Embodiment 1 will be omitted here. The difference between Embodiment 1 and Embodiment 4 is only S260 in FIG. 5.

<Procedure for Determination on Whether or Not Lane Changing is Possible> FIG. 18 is a flowchart representing a procedure for a determination on whether or not lane changing is possible according to Embodiment 4. This processing is performed in S260 in FIG. 5.

Except that the connecting lane is different, processing the same as that in the steps S261 through S263 is performed in the steps S261 through S263.

Next, in S264 in FIG. 18, it is determined whether or not it has been determined in S263 that the lane changing is possible. In the case where it is determined that it has been determined that the lane changing is possible, the processing in S267 is performed. In the case where it is determined that it has been determined that the lane changing is impossible, the processing in S265 is performed.

In the case where it is determined in S264 in FIG. 18 that it has been determined that the lane changing is possible, it is determined in S265 in FIG. 18 whether or not there exists a margin for regenerating the target trajectory within the calculation time. In the case where it is determined that there exists a margin, the processing in S266 is performed. In the case where it is determined that there exists no margin, the processing in S268 is performed.

Whether or not there exists a margin in the calculation time is determined, for example, based on an execution period Te of the steps S210 through S270 in FIG. 5, a time Tp required for processing in the steps S210 through S270, and a time Tg required for generation of the target trajectory in S250. For example, it is assumed that the execution period Te of the steps S210 through S270 is 10 ms, that the time Tp required for processing in the steps S210 through S270 is 5 ms, and that the time Tg required for generation of the target trajectory in S250 is 1/Ms. In this situation, a margin time Tm is 5 ms, which is the difference between the execution period Tm and the processing time Tp. Because the generation time Tg is 1/Ms, the target trajectory can be recurrently generated at most five times in S250. Then, for example, in the case where there exists a margin for recurrently generating the target trajectory at least twice, it is determined that there exists a margin in the calculation time. In this regard, however, the method of determining whether or not there exists a margin in the calculation time is not limited to the foregoing method.

In the case where in S265 in FIG. 18, it is determined that there exists a margin for regenerating the target trajectory in the calculation time, the target lane changing trajectory is generated again in S266 in FIG. 18. After the regeneration, S263 in FIG. 18 is resumed.

In the present embodiment, the optimization problem is changed in S266 in FIG. 18, and then S250 in FIG. 5 is performed again, i.e., the target lane changing trajectory ξLC is generated again by solving the optimization problem again.

The optimization problem is changed in such a way that it is likely to be determined that lane changing is possible. For example, the upper limit value and the lower limit value of the control input to be set in each of the equations (305) and (306) are relaxed. Alternatively, the target required time tLC may be prolonged. Alternatively, the entry prohibition region may be narrowed, as long as no safety problem is caused.

In the case where it is determined in S264 in FIG. 18 that lane changing is possible or in the case where it is determined in S262 in FIG. 18 that the target action in the immediately previous period is not lane changing, the target lane changing trajectory ξLC is outputted, as the target trajectory in S267 in FIG. 18.

In the case where it is determined in S265 in FIG. 18 that there exists no margin in the calculation time, the target lane keeping trajectory ξLK is generated in S268 in FIG. 18. The generation method is the same as that in S266 in FIG. 7.

Next, in S269 in FIG. 18, the target lane keeping trajectory ξLK is outputted, as the target trajectory.

<Summary of Embodiment 4> In such a configuration, for example, in the case where lane changing becomes possible by slightly relaxing the restriction on the control inputs, it can be determined that the lane changing is possible; thus, because the opportunity for the lane changing is hardly missed, the comfortability for the drier is raised.

Embodiment 5. In Embodiment 1, in the case where it is determined that lane changing is impossible, the target lane keeping trajectory ξLK is generated based on the stored target lane keeping trajectory ξLK. In the case where this method is utilized and hence the decision making section 230 continues outputting the target action of lane changing in the situation where it is determined that lane changing is impossible, generation of the target lane keeping trajectory ξLK based on the stored target lane keeping trajectory ξLK is continued during the particular period. Accordingly, no change in the surrounding environment can be reflected in the target lane keeping trajectory ξLK and hence the safety is deteriorated. Accordingly, in the case where the determination section 260 determines that lane changing is impossible, it may be allowed that the determination result is fed back to the decision making section 230 and the decision making section 230 outputs no prohibition-period target action of lane changing. As a result, it can be prevented that no change in the surrounding environment can be reflected in the target lane keeping trajectory ξLK for two or more continual periods; thus, the safety is raised.

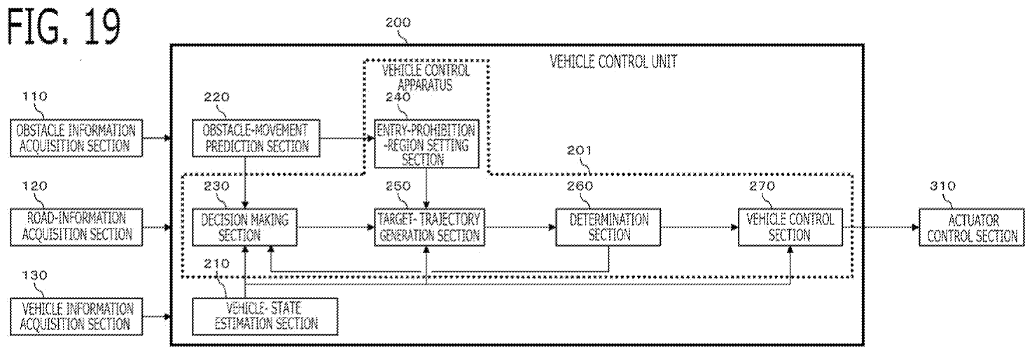

Hereinafter, Embodiment 5 will be explained. The explanation therefor that overlaps with the explanation for Embodiment 1 will be omitted here.

<Block Diagram> FIG. 19 is a block diagram representing an example of a vehicle control apparatus 201 according to Embodiment 5 of the present disclosure. The vehicle control apparatus 201 in FIG. 19 includes the decision making section 230, the entry-prohibition-region setting section 240, the target-trajectory generation section 250, the determination section 260, and the vehicle control section 270.

The difference from FIG. 1 is that the vehicle control apparatus 201 has the decision making section 230 and the determination section 260 feeds back a determination result to the decision making section 230.

<Procedure for Decision Making> In the present embodiment, the determination section 260 feeds back a determination result to the decision making section 230. Then, in the case where a determination that lane changing is impossible is fed back, the decision making section 230 prohibits, for a predetermined period, the target action from being set to lane changing. In other words, the target action is set to lane keeping for the predetermined period. The predetermined period is to be, for example, the same as or longer than the execution period of each of the target-trajectory generation section 250 and the determination section 260. Accordingly, the determination section 260 does not determine for two or more continual periods that the lane changing is impossible; thus, the target lane keeping trajectory ξLK is prevented from being generated based on the target lane keeping trajectory ξLK that has been stored for two continual periods. As a result, it can be prevented that no change in the surrounding environment can be reflected in the target lane keeping trajectory ξLK for two or more continual periods; thus, the safety is raised.

<Summary of Embodiment 5> In such a configuration, it can be prevented that no change in the surrounding environment can be reflected in the target lane keeping trajectory ξLK for two or more continual periods; thus, the safety is raised.

Embodiment 6. In Embodiment 1, the entry prohibition region is set based on the movement prediction for an obstacle; however, it may be allowed that the entry prohibition region is changed in accordance with the reliability of the movement prediction. As a result, the number of false negatives or false positives in determinations whether or not lane changing is possible can be reduced.

Hereinafter, Embodiment 6 will be explained. The explanation therefor that overlaps with the explanation for Embodiment 1 will be omitted here.

<Reliability of Movement Prediction> In the present embodiment, the obstacle-movement prediction section 220 outputs a movement prediction with reliability. As a calculation method for the movement prediction with reliability, for example, there is utilized a neural network that receives the center position (Xo(0), Yo(0)) of an obstacle, the vehicle body yaw angle θo(0), and the velocity Vo(0) at the present time point, obtained by the obstacle information acquisition section 110, and outputs the center position (Xo(k), Yo(k)) of the obstacle, the vehicle body yaw angle θo(k), and the velocity Vo(k) at the prediction point k (k=0, . . . , N) and the reliability. In addition, the performance of the sensor in the obstacle information acquisition section 110 may further be inputted to the neural network.

In the present embodiment, as the reliability of the movement prediction, the following two patterns are considered.

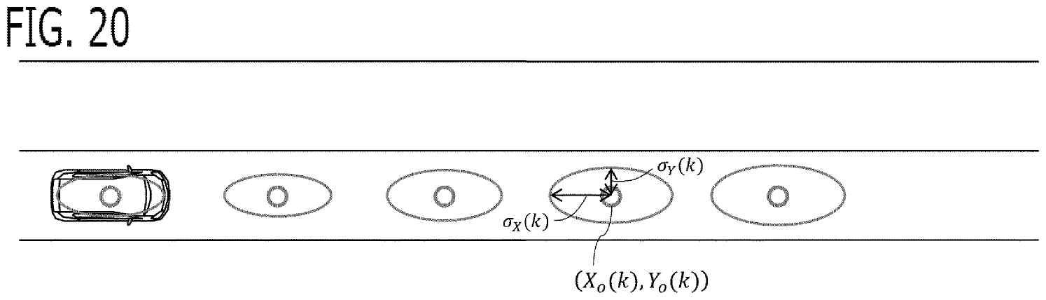

(Pattern 1) As represented in FIG. 20, errors σX(k) and σY(k) are provided with respect to the center position (Xo(k), Yo(k)) of the obstacle at each of the prediction points.

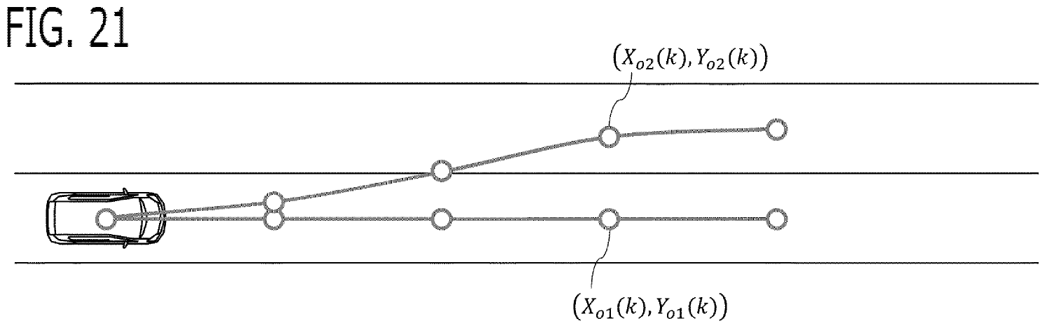

(Pattern 1) As represented in FIG. 21, there exist M movement predictions for an obstacle, and the selection probability pl (1=1, . . . , M) (Σ^{M}ₗ₌₁pl=1) for each of the movement predictions is provided. In addition to that, the center position (Xol(k), Yol(k)) of the obstacle, the vehicle body yaw angle θol(k), and the velocity Vol(k) at each of the respective prediction points for the movement predictions are provided.

<Setting Procedure for Entry Prohibition Region> The step S240 in FIG. 5 according to Embodiment 6 will be explained. In the present embodiment, the entry-prohibition-region setting section 240 changes the entry prohibition region in accordance with the reliability of the movement prediction.

As a method of changing the entry prohibition region at a time when the reliability is provided according to Pattern 1, for example, the major axis la(k) and the minor axis lb(k) of the ellipse at each of the prediction points are extended by the respective amounts corresponding to the errors σX(k) and σY(k). As a result, in the case where the error in the movement prediction is large, it is hardly determined that lane changing is possible; thus, the false positives can be reduced.

In the case where the reliability is provided according to Pattern 2, for example, the entry prohibition region is set for the movement prediction whose selection probability pl is maximum. Then, as a method of changing the entry prohibition region, for example, the major axis la and the minor axis lb of the ellipse are adjusted in accordance with the selection probability pl. For example, when the selection probability pl is larger than a predetermined reference probability pb, the major axis la and the minor axis lb of the ellipse are prolonged; when the selection probability pl is smaller than the predetermined reference probability pb, the major axis la and the minor axis lb of the ellipse are shortened. As a result, in the case where the selection probability pl is large, it is hardly determined that lane changing is possible; thus, the false positives can be reduced. In the case where the selection probability pl is small, it becomes liable to be determined that lane changing is possible; thus, the false negatives can be reduced. The predetermined reference probability pb is, for example, the expected value 1/M. In addition, the entry prohibition region may be set at a movement prediction point other than the movement prediction point where the selection probability pl is maximum.

<Summary of Embodiment 6> In such a configuration, because the entry prohibition region can be changed in accordance with the reliability of the movement prediction, the number of false negatives or false positives in determinations whether or not lane changing is possible can be reduced.

Embodiment 7. In Embodiment 1, the determination whether or not lane changing is possible is performed only when the lane changing is started; however, whether or not the lane changing may be determined while the lane changing is continued. Accordingly, in the case where an obstacle takes an unexpected action while the lane changing is continued and hence the lane changing becomes impossible, the lane changing can correctly be interrupted. As a result, the safety is raised.

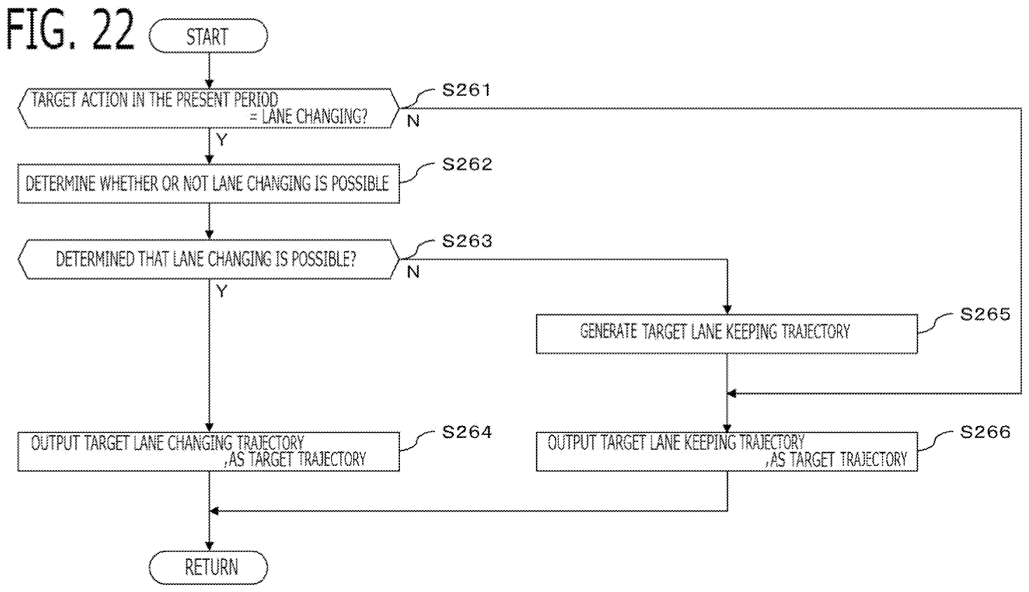

Hereinafter, Embodiment 7 will be explained. The explanation therefor that overlaps with the explanation for Embodiment 1 will be omitted here.

<Procedure for Determination on Whether or Not Lane Changing is Possible> FIG. 22 is a flowchart representing a procedure for a determination on whether or not lane changing is possible according to Embodiment 7. This processing is performed in S260 in FIG. 5.

Except that the connecting lane is different, processing the same as that in S261 in FIG. 7 is performed in S261 in FIG. 22. In the case where in S261 in FIG. 22, it is determined that the present target action is lane changing, whether or not the lane changing is possible is performed in S262 in FIG. 22. The determination methos is the same as that in Embodiment 1.

Next, in S263 in FIG. 22, it is determined whether or not it has been determined in S262 that the lane changing is possible. In the case where it is determined that it has been determined that the lane changing is possible, the processing in S264 is performed. In the case where it is determined that it has been determined that the lane changing is impossible, the processing in S265 is performed.

In the case where it is determined in S263 in FIG. 22 that it has been determined that the lane changing is possible, the target lane changing trajectory ξLC is outputted, as the target trajectory in S264 in FIG. 22.

In the case where it is determined in S263 in FIG. 22 that it has been determined that the lane changing is impossible, the target lane keeping trajectory ξLK is generated in S265 in FIG. 22.

In the present embodiment, in S265 in FIG. 22, the target action is changed to lane keeping, the target lane is changed to the original lane, and then S250 in FIG. 5 is performed again; that is to say, the target lane keeping trajectory ξLK is generated by solving an optimization problem again.

Next, in S266 in FIG. 22, the target lane keeping trajectory ξLK is outputted, as the target trajectory.

<Summary of Embodiment 7> In such a configuration, in the case where an obstacle takes an unexpected action while the lane changing is continued and hence the lane changing becomes impossible, the lane changing can correctly be interrupted. As a result, the safety is raised.

In addition, it may be allowed that in order to prevent hunting of the result of a determination whether or not lane changing is possible, the optimization problem is changed in such a way that the easiness of being determined that lane changing is possible differs between the time when the lane changing starts and other times. That is to say, at a time when lane changing is started, the optimization problem is set in such a way that it is not likely to be determined that the lane changing is possible; in contrast, while the lane changing is continued, the optimization problem is set in such a way that it is likely to be determined that the lane changing is possible. As a result, it can be prevented that immediately after it is determined that lane changing is possible, it is determined that the lane changing is impossible; thus, no feeling of discomfort is provided to the driver. As a method of changing the easiness of being determined that lane changing is possible, the method that has been explained in Embodiment 4 is utilized.

### <Summary of Respective Features of the Present Disclosure>

Hereinafter, respective features disclosed in the present disclosure will collectively be described as appendixes.

(Appendix 1) A vehicle control apparatus comprising: an entry-prohibition-region setting section that sets an entry prohibition region of an ego vehicle, based on movement prediction for an obstacle; a target-trajectory generation section that calculates a target trajectory for the ego vehicle to change a lane to a target lane in the prediction-period future under restriction of not entering the entry prohibition region; a determination section that determines whether or not the ego vehicle can change a lane, based on the target trajectory; and a vehicle control section that makes the ego vehicle change a lane by use of the target trajectory, when the determination section determines that the ego vehicle can change the lane, wherein the target trajectory includes information related to at least a position of the ego vehicle, and wherein the determination section determines whether or not lane changing is possible, based on at least information on a position of the ego vehicle in the target trajectory.

(Appendix 2) The vehicle control apparatus according to Appendix 1, wherein the determination section determines whether or not lane changing is possible, based on an attainment degree of the target trajectory to the target lane or based on a degree of divergence between the target trajectory and a reference lane changing trajectory that is a target trajectory, for performing lane changing to the target lane, that is calculated without the restriction of not entering the entry prohibition region.

(Appendix 3) The vehicle control apparatus according to any one of Appendixes 1 and 2, wherein the target trajectory further includes information related to steering of the ego vehicle, and
wherein the determination section determines whether or not lane changing is possible, based also on steering maneuver of the target trajectory.

(Appendix 4) The vehicle control apparatus according to Appendix 3, wherein the steering maneuver is the number of steering changes.

(Appendix 5) The vehicle control apparatus according to any one of Appendixes 1 through 4, wherein the target-trajectory generation section calculates the target trajectory by use of restriction that limits any one or more of a velocity, longitudinal acceleration, lateral acceleration, longitudinal jerk, and lateral jerk of the ego vehicle with respective upper and under limit values.

(Appendix 6) The vehicle control apparatus according to any one of Appendixes 1 through 5, wherein when determining that lane changing is impossible, the determination section changes a condition in such a way that it is likely to be determined that lane changing is possible and then calculates the target trajectory again.

(Appendix 7) The vehicle control apparatus according to Appendix 6, wherein the condition is any one of restrictions that have been set or a target required time for lane changing.

(Appendix 8) The vehicle control apparatus according to any one of Appendixes 1 through 7, further comprising a decision making section that decides a target action to be taken by the ego vehicle and a target lane on which the ego vehicle should travel, wherein when the determination section determines that lane changing is impossible, the decision making section dose not set the target action to lane changing for at least a prohibition period.

(Appendix 9) The vehicle control apparatus according to any one of Appendixes 1 through 8, wherein the entry-prohibition-region setting section changes the entry prohibition region in accordance with reliability of movement prediction for the obstacle.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the specification of the present disclosure. For example, at least one of the constituent components may be modified, added, or eliminated; moreover, at least one of the constituent components mentioned in at least one of the preferred embodiments may be selected and combined with the constituent components mentioned in another preferred embodiment.

What is claimed is:

1. A vehicle control apparatus comprising at least one processor configured to implement: an entry-prohibition-region setter that sets an entry prohibition region of an ego vehicle, based on movement prediction for an obstacle; a target-trajectory generator that calculates a target trajectory for the ego vehicle to change a lane to a target lane in the prediction-period future under restriction of not entering the entry prohibition region;
a determiner that determines whether or not the ego vehicle can change a lane, based on the target trajectory; and a vehicle controller that makes the ego vehicle change a lane by use of the target trajectory, when the determiner determines that the ego vehicle can change the lane, wherein the target trajectory includes information related to at least a position of the ego vehicle, and wherein the determiner determines whether or not lane changing is possible, based on at least information on a position of the ego vehicle in the target trajectory.

2. The vehicle control apparatus according to claim 1, wherein the determiner determines whether or not lane changing is possible, based on an attainment degree of the target trajectory to the target lane or based on a degree of divergence between the target trajectory and a reference lane changing trajectory that is a target trajectory for performing lane changing to the target lane and is calculated without the restriction of not entering the entry prohibition region.

3. The vehicle control apparatus according to claim 1,
wherein the target trajectory further includes information related to steering of the ego vehicle, and wherein the determiner determines whether or not lane changing is possible, based also on steering maneuver of the target trajectory.

4. The vehicle control apparatus according to claim 3, wherein the steering maneuver is a number of steering changes.

5. The vehicle control apparatus according to claim 1, wherein the target-trajectory generator calculates the target trajectory by use of restriction that limits any one or more of a velocity, a longitudinal acceleration, a lateral acceleration, a longitudinal jerk, and a lateral jerk of the ego vehicle with respective upper and under limit values.

6. The vehicle control apparatus according to claim 1, wherein when determining that lane changing is impossible, the determiner changes a condition in such a way that it is likely to be determined that lane changing is possible and then calculates the target trajectory again.

7. The vehicle control apparatus according to claim 6, wherein the condition is any one of restrictions that have been set or a target required time for lane changing.

8. The vehicle control apparatus according to claim 1, further comprising a decision maker that decides a target action to be taken by the ego vehicle and a target lane on which the ego vehicle should travel,
wherein when the determiner determines that lane changing is impossible, the decision maker set the target action to an action other than lane changing for at least a prohibition period.

9. The vehicle control apparatus according to claim 1, wherein the entry-prohibition-region setter changes the entry prohibition region in accordance with reliability of movement prediction for the obstacle.
